(19) United States
(12) Patent Application Publication
(10) Pub. No.: US 2024/0088693 A1
(43) Pub. Date: Mar. 14, 2024

(54) SYSTEMS AND METHODS FOR SCHEDULE-BASED CHARGING OF DEVICE BATTERIES

(71) Applicant: Sonos, Inc., Santa Barbara, CA (US)

(72) Inventors: Joern Riemer, Santa Barbara, CA (US); James Nesfield, Edinburgh (GB); Sean Simon, Boston, MA (US); Robert Tice, Boston, MA (US)

(21) Appl. No.: 18/451,973

(22) Filed: Aug. 18, 2023

Related U.S. Application Data
(60) Provisional application No. 63/375,359, filed on Sep. 12, 2022.

(51) Int. Cl. H02J 7/00

(52) U.S. Cl. CPC H02J 7/0071; H02J 7/00034; H02J 7/00302; H02J 7/0048

(57) ABSTRACT

The media playback system comprises a first playback device with an energy storage having a maximum storage capacity. The media playback system sets a target charge level for the first energy storage to a first maximum charge threshold, wherein the first charge threshold is less than the maximum storage capacity (e.g., 20% of the maximum storage capacity). In response to identifying an event associated with a user, the media playback system adjusts the target charge level for the first energy storage to a second maximum charge threshold, wherein the second charge threshold is based on a duration of the first event. Subsequently, the media playback system receives power from a first power source to charge the first energy storage to the second maximum charge threshold. After the first event ends, the media playback system adjusts the target charge level for the first energy storage to the first maximum charge threshold.

### CROSS-REFERENCE TO RELATED APPLICATION

This application claims the benefit of priority to U.S. Provisional Patent Application No. 63/375,359, filed Sep. 12, 2022, which is herein incorporated by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 2D is a diagram of another example housing for a playback device.

FIG. 2E is a diagram of another example housing for a playback device.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows a front view of a control device.

FIG. 6 shows a message flow diagram of a media playback system.

FIG. 7 shows an example configuration of a wireless power transfer device in accordance with the disclosed technology.

FIG. 8 shows an example configuration of a wireless power group in accordance with the disclosed technology.

FIG. 9 illustrates an example method 900 for updating charging schemes of one or more playback devices based on scheduling information in accordance with some embodiments of the disclosed technology.

FIG. 10 illustrates an example method 1000 for identifying events based on scheduling information in accordance with some embodiments of the disclosed technology.

FIG. 11 illustrates an example method 1100 for updating a charging scheme for a device based on scheduling information in accordance with some embodiments of the disclosed technology.

FIGS. 12A-12B illustrate examples of device charging schemes in accordance with the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

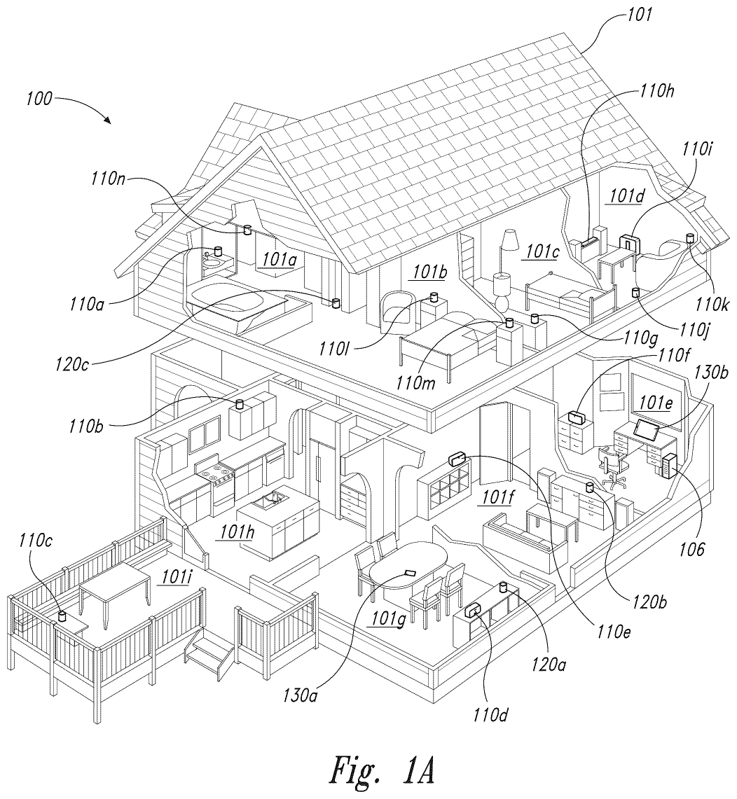

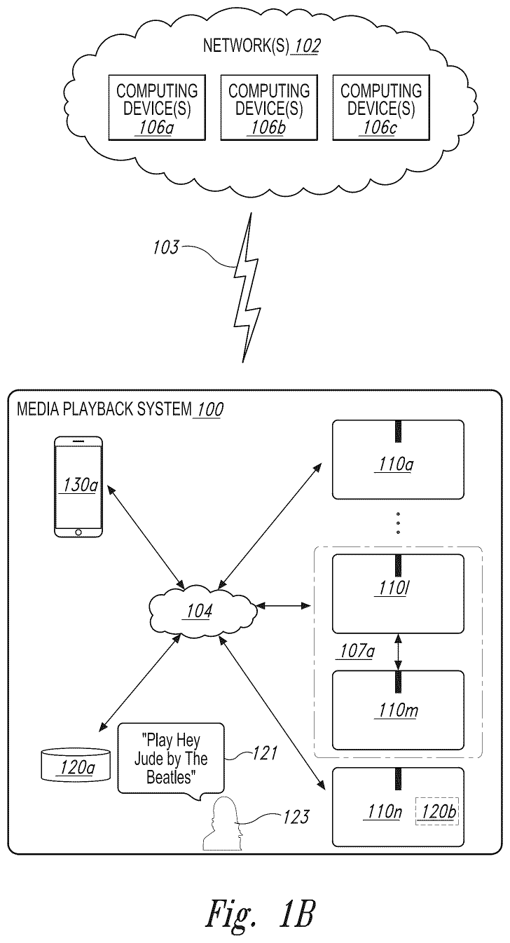

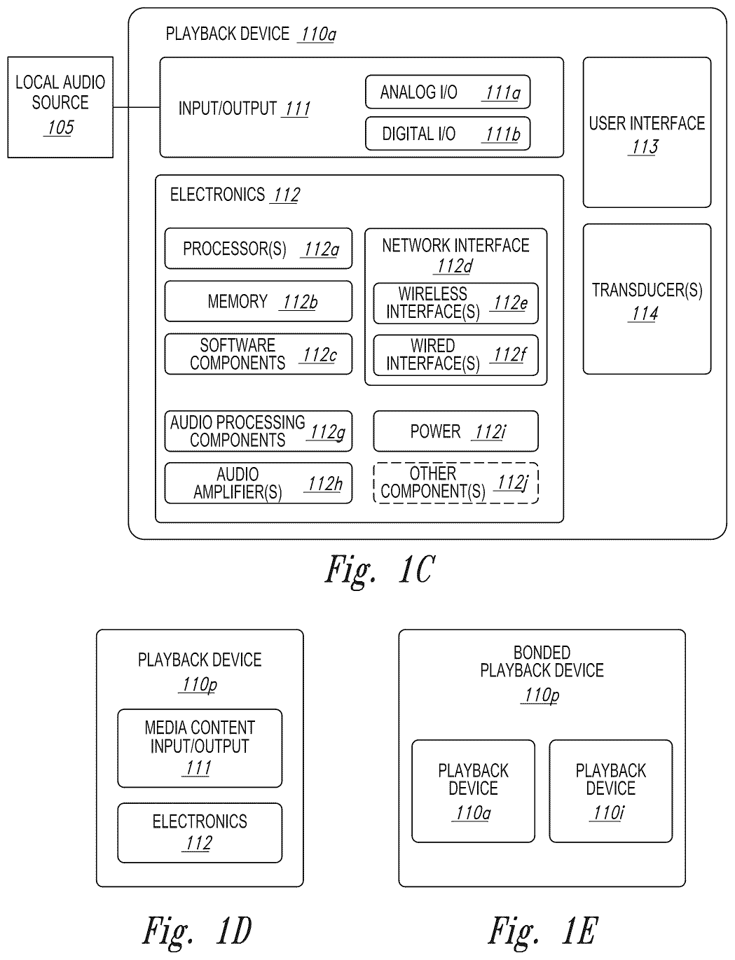

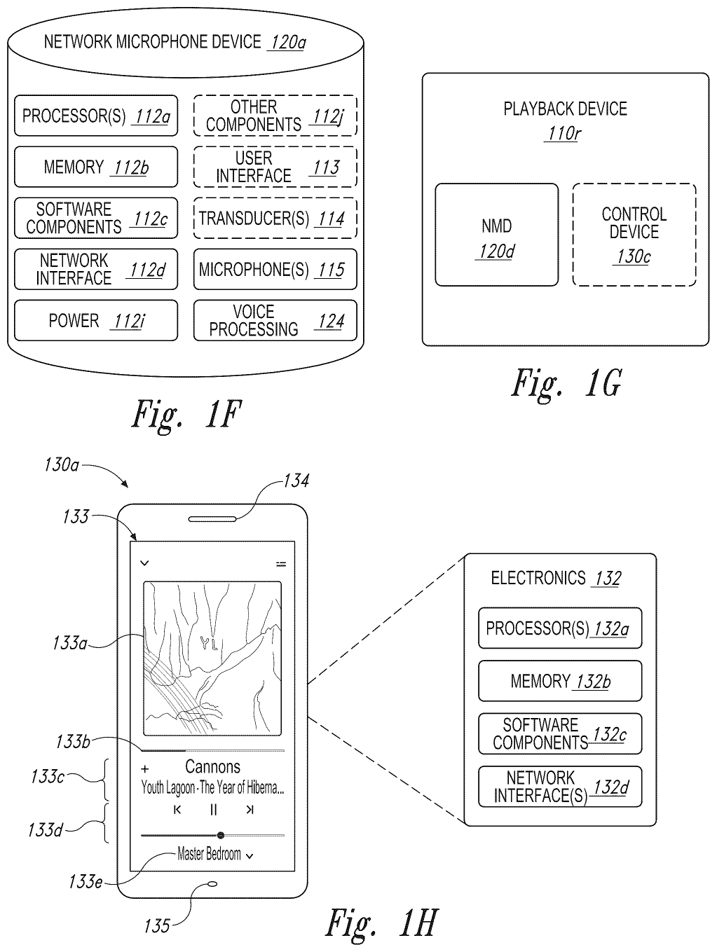

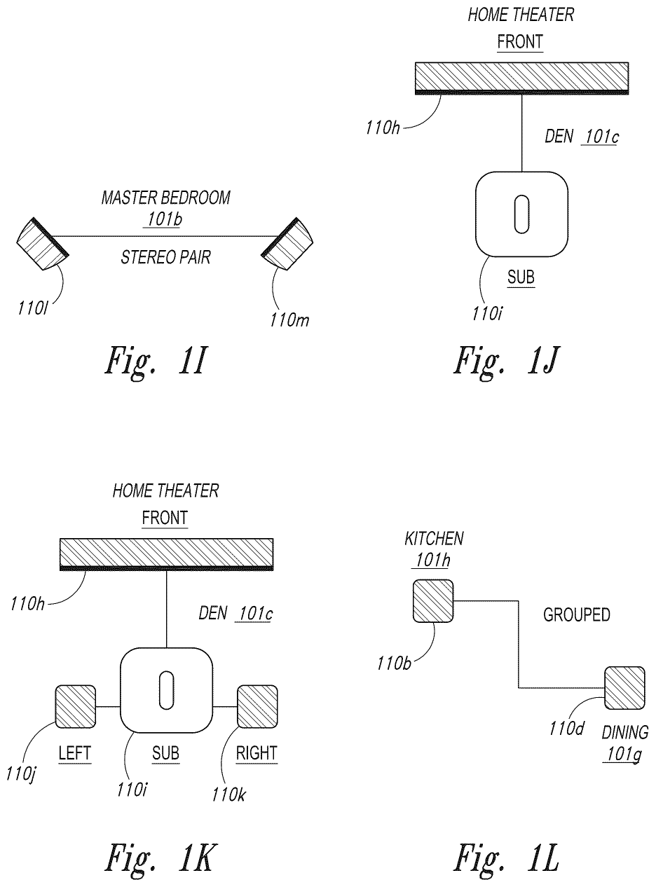

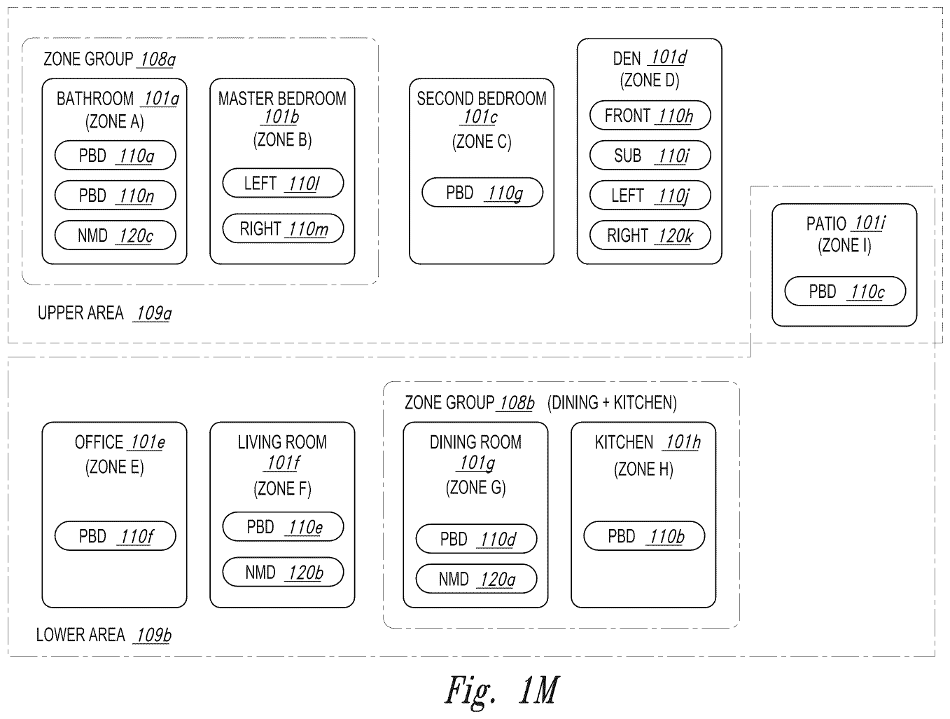

Conventional media playback systems often include one or more playback devices, such as playback devices 110 (FIG. 1A), that include one or more rechargeable energy stores or batteries. These rechargeable batteries allow users to use and re-use devices without the need to purchase new batteries to replace dead batteries. Moreover, these playback devices often use standardized charging ports and connector types (e.g., USB-A, USB-B, USB-C, APPLE LIGHTNING®, etc.) so that these devices can be charged and re-charged without specialized cabling and/or hardware, thereby enhancing the portability and usability of these playback devices. Batteries made of certain chemistries (e.g., lithium ion, lithium polymer, nickel-metal hydride) may see their performance and capacities degrade faster based on charging conditions. For example, charging a lithium-ion battery to 100% state of charge (SOC) is usually not advisable due to the currents and/or voltages needed to continue to charge the battery beyond an upper charge threshold (e.g., 95% SOC). Conversely, charging lithium-ion batteries using a low charging rate or “C-Rate” (e.g., less than or equal to 0.5C, 0.7C, etc.) rather than a high charging rate (e.g., greater than 1.5C, 2C, etc.) can significantly extend battery lifetime. In many instances, selecting a lower charge threshold significantly less than full capacity (e.g., 30%, 40%, or 50% SOC) may extend battery lifetime further. Charging to a lower charge threshold, however, can limit runtime when the device is powered exclusively via battery power. Accordingly, it would be beneficial to use scheduling information to anticipate when a device may be powered exclusively via battery power (and when the device may have access to other sources of energy) and set a maximum charge threshold for the device according to its present and future needs.

The disclosed playback devices, media playback systems, and/or methods can improve upon battery performance and battery lifetime by employing scheduling information, such as scheduling information related to events, travel plans, energy harvesting opportunities, usage history, and so on as a basis for setting charge thresholds, charging times and duration, charge rates, and so on. Moreover, the playback devices can take advantage of playback device group dynamics to offload or share responsibilities amongst or between playback devices in the group based on scheduling information to prolong the battery life of one or more devices. The disclosed media playback system employs different charging schemes for playback devices in an effort to reduce battery degradation and preserve or prolong battery life. By permitting batteries to be charged based on scheduling information to reduce battery degradation and lengthen battery life, the media playback system's utility to one or more users is improved as compared to conventional approaches.

In some embodiments, the media playback system comprises a first playback device with an energy storage having a maximum electric charge storage capacity (e.g., 1000 mAh, 2500 mAh, 5000 mAh). The media playback system sets a target charge level for the first energy storage to a first maximum charge threshold, wherein the first charge threshold is less than the maximum storage capacity (e.g., 20%, 30%, 40%, 50% of the maximum storage capacity). In response to identifying an event associated with a user, the media playback system adjusts the target charge level for the first energy storage to a second maximum charge threshold, wherein the second charge threshold is based on a duration of the first event so that the first energy storage can be charged to the second maximum charge threshold. Subsequently, the media playback system receives energy from a first power source to charge the first energy storage to the second maximum charge threshold. After the first event ends, the media playback system adjusts the target charge level for the first energy storage to the first maximum charge threshold so that the first energy storage will be charged to the first maximum charge threshold.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and playback timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WiFi networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the playback device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more of earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback.

In some instances, the headphone device may take the form of a hearable device. Hearable devices may include those headphone devices (e.g., ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a projector, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

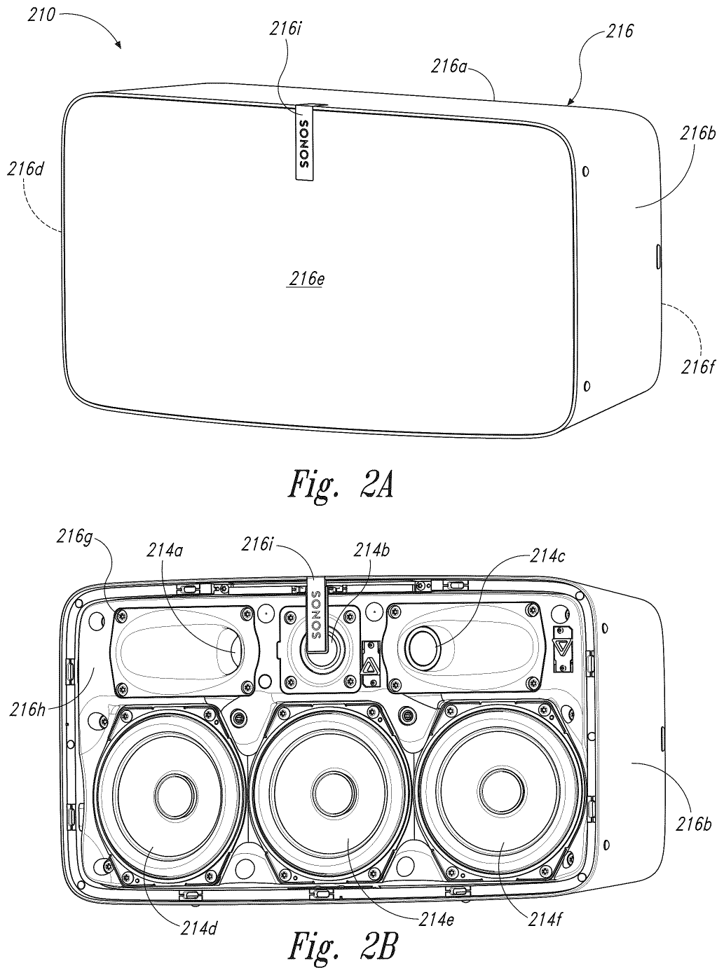

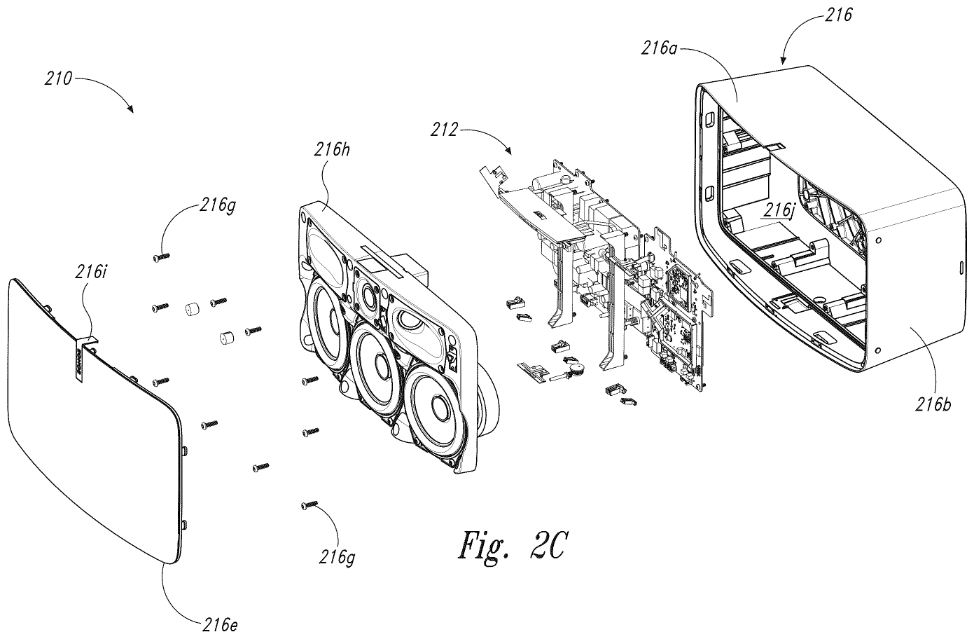

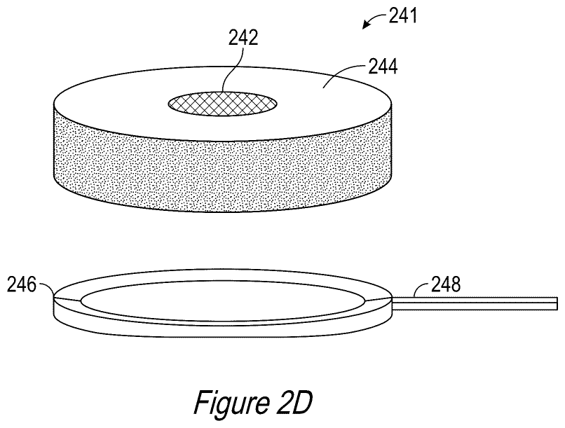

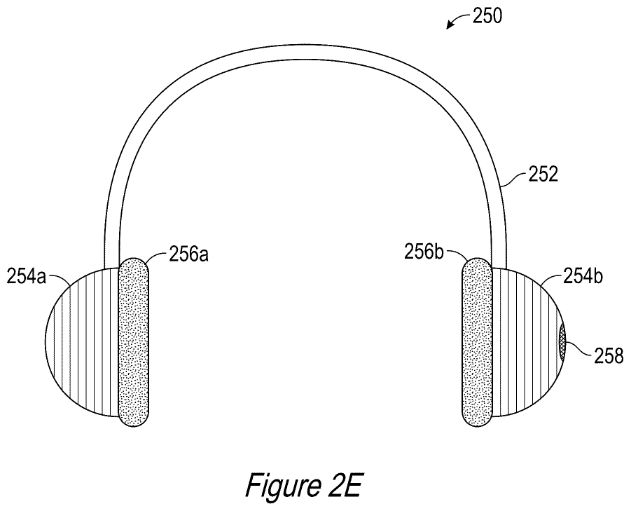

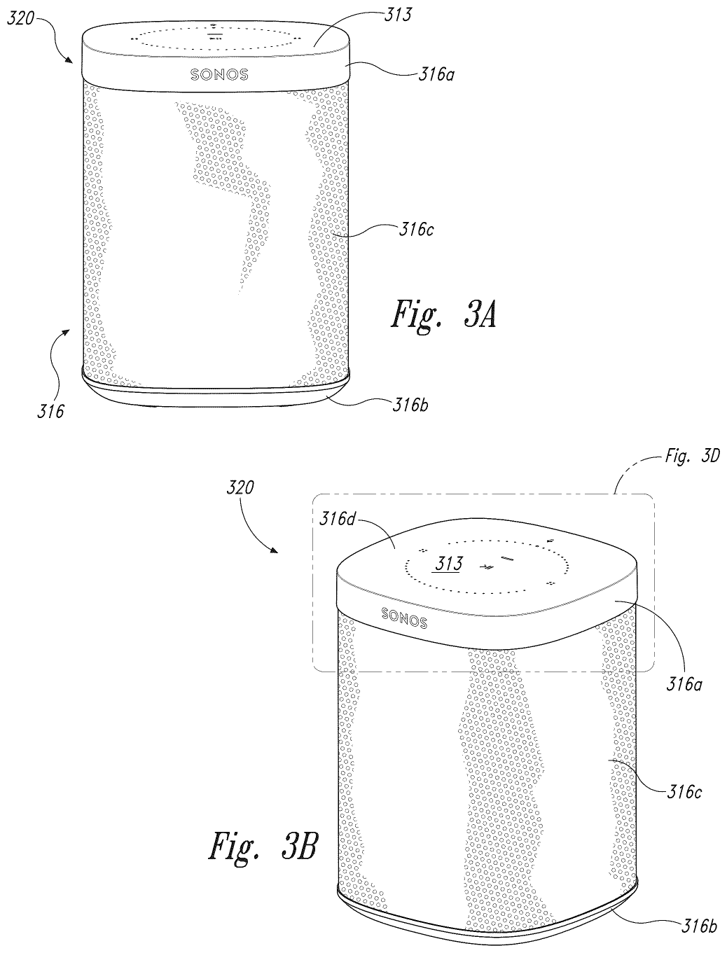

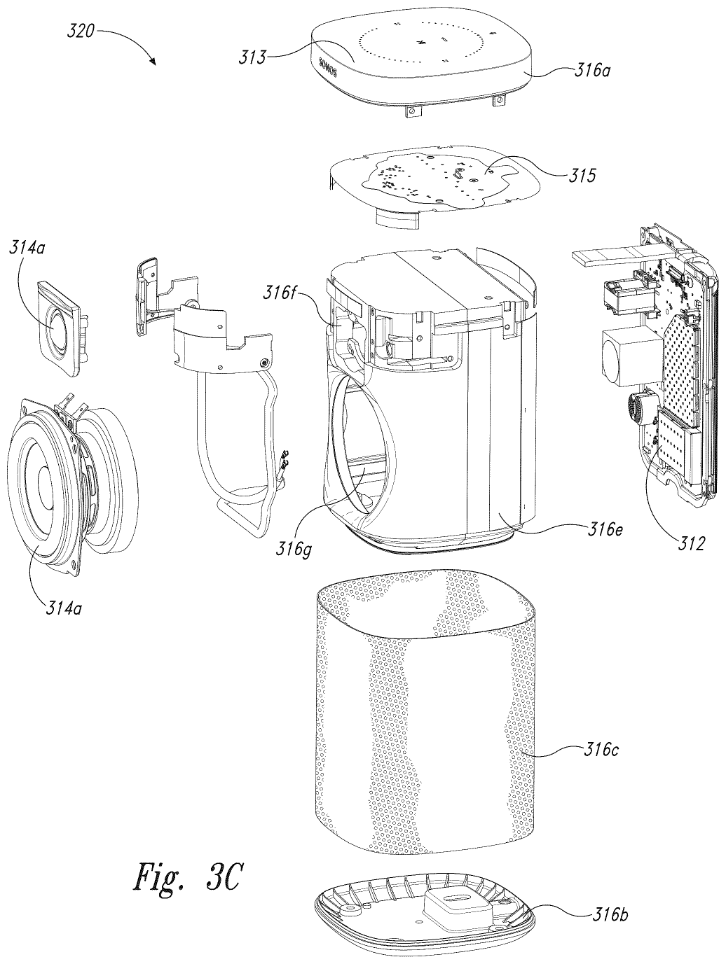

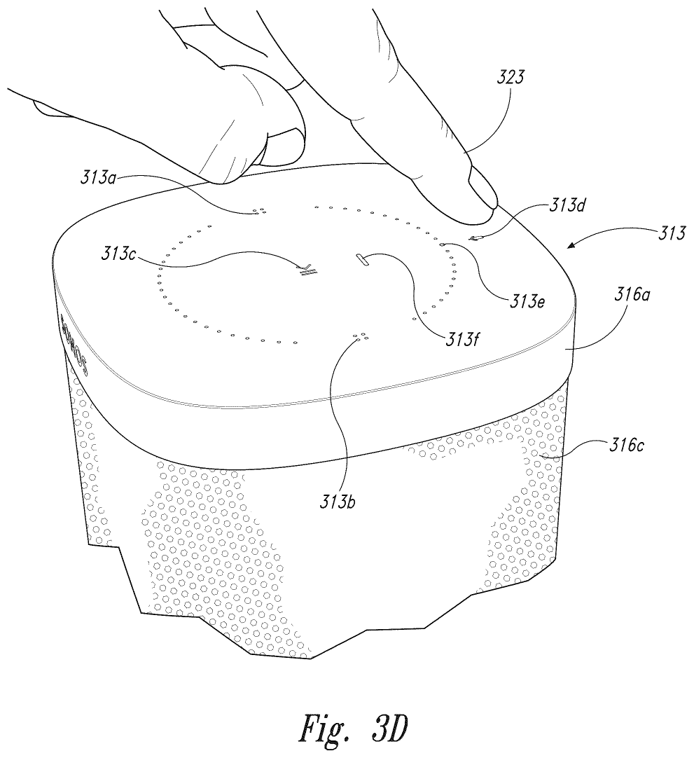

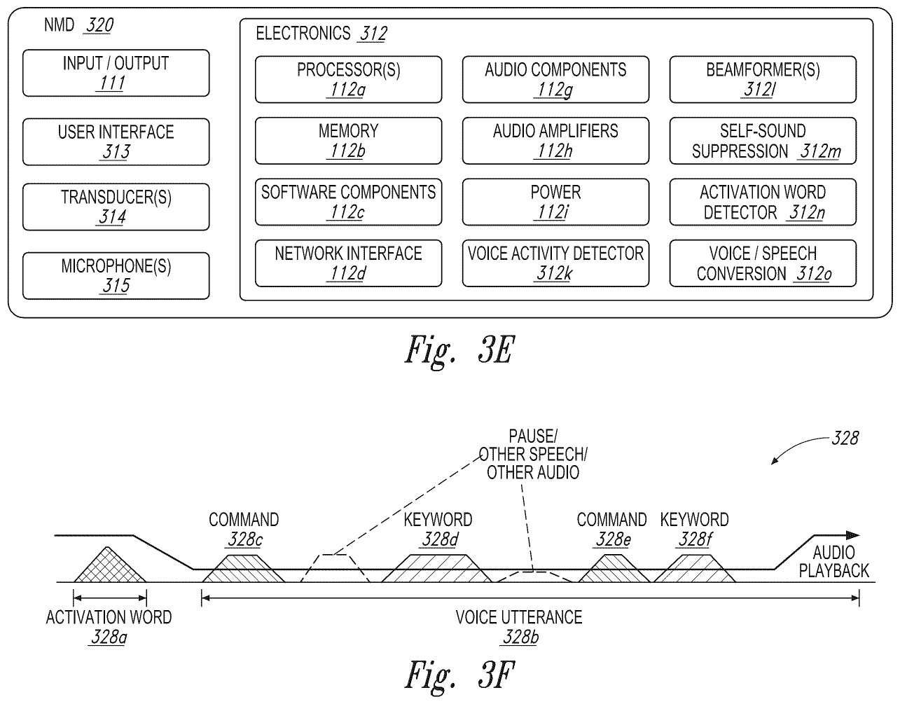

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad′), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

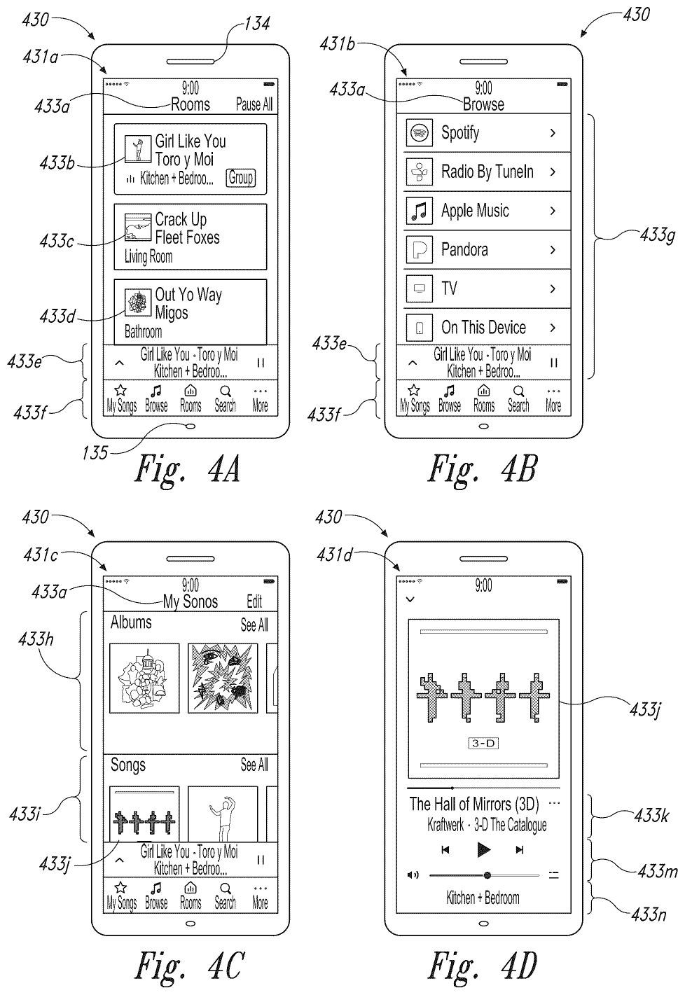

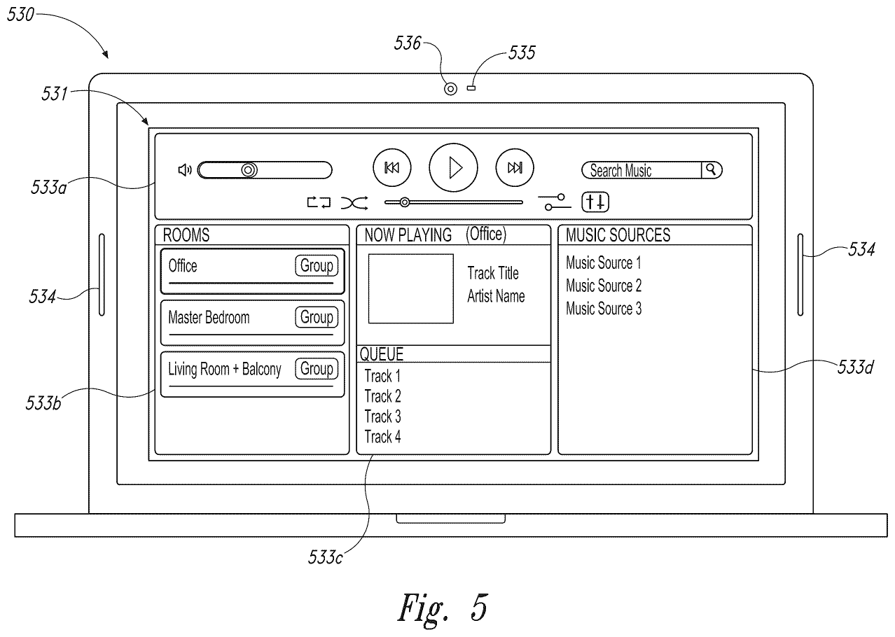

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

In some examples, the playback device 102 may be constructed as a portable playback device, such as an ultra-portable playback device, that comprises an internal power source. FIG. 2D shows an example housing 241 for such a portable playback device. As shown, the housing 241 of the portable playback device includes a user interface in the form of a control area 242 at a top portion 244 of the housing 241. The control area 242 may include a capacitive touch sensor for controlling audio playback, volume level, and other functions. The housing 241 of the portable playback device may be configured to engage with a dock 246 that is connected to an external power source via cable 248. The dock 246 may be configured to provide power to the portable playback device to recharge an internal battery. In some examples, the dock 246 may comprise a set of one or more conductive contacts (not shown) positioned on the top of the dock 246 that engage with conductive contacts on the bottom of the housing 241 (not shown). In other examples, the dock 246 may provide power from the cable 248 to the portable playback device without the use of conductive contacts. For example, the dock 246 may wirelessly charge the portable playback device via one or more inductive coils integrated into each of the dock 246 and the portable playback device.

In some examples, the playback device 102 may take the form of a wired and/or wireless headphone (e.g., an over-ear headphone, an on-ear headphone, or an in-ear headphone). For instance, FIG. 2E shows an example housing 250 for such an implementation of the playback device 102. As shown, the housing 250 includes a headband 252 that couples a first earpiece 254a to a second earpiece 254b. Each of the earpieces 254a and 254b may house any portion of the electronic components in the playback device, such as one or more speakers, and one or more microphones. In some instances, the housing 250 can enclose or carry one or more microphones. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include ear cushions 256a and 256b that are coupled to earpieces 254a and 254b, respectively. The ear cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy or power source and weigh less than fifty ounces.

In some examples, the playback device 102 may take the form of an in-ear headphone device. It should be appreciated that the playback device 102 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback device 102 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

While specific implementations of playback and network microphone devices have been described herein, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other playback devices and/or computing devices rather than those described herein. Further, although a specific example of playback device 102 is described with reference to MPS 100, one skilled in the art will recognize that playback devices as described herein can be used in a variety of different environments, including (but not limited to) environments with more and/or fewer elements, without departing from this invention. Likewise, MPS s as described herein can be used with various different playback devices.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes, or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 3280. In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as a playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

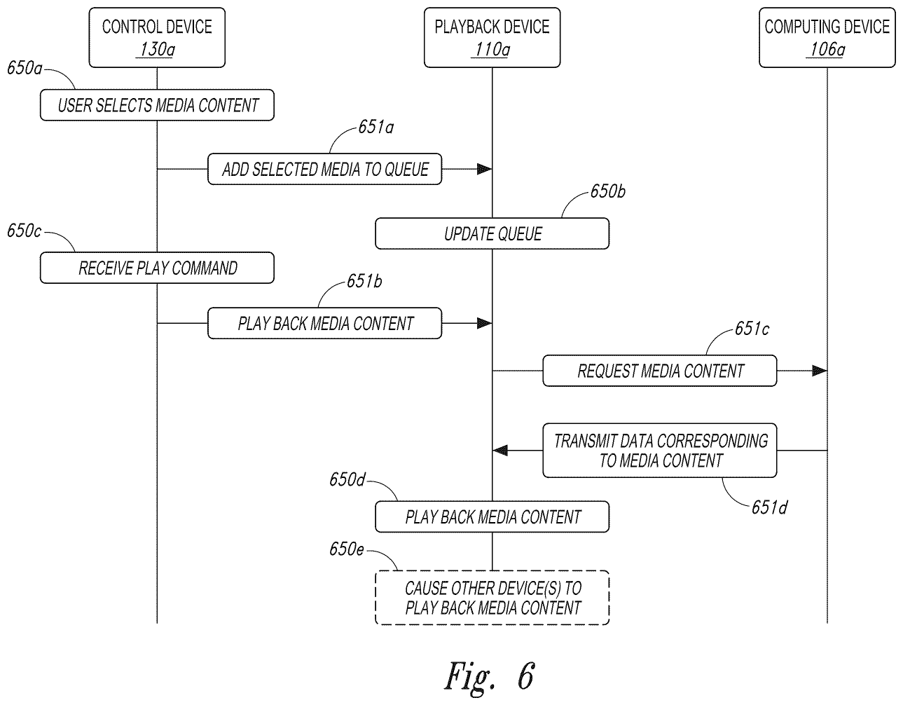

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Wireless Power Transfer Devices and Associated Systems and Methods

Audio playback devices capable of receiving wireless power provide several distinct advantages over conventional wired devices. For example, there is no need to hide unsightly power cords by routing them through a wall or underneath furniture. Wireless power transfer may also allow a user to reposition devices more easily around a home or room without needing to disconnect or re-route power cords. To enable this functionality, one or more wireless power transmitter devices can be provided in the vicinity of an audio playback device having a wireless power receiver therein. Such a transmitter device can include another playback device (e.g., a soundbar, subwoofer, or any playback device having a wired power connection), or a non-playback device (e.g., a power hub that provides wireless power to the playback device without itself driving audio output). In some examples, one or more playback devices can include both a wireless power receiver and a wireless power transmitter, such that these devices may be used in either configuration, or in some instances may be used in both configurations simultaneously (e.g., as a “relay” in which a device receives wireless power from an external transmitter device and transmits wireless power to an external receiver device). In some instances, a plurality of such playback devices can transfer wireless power among one another in a mesh configuration, with the particular device-to-device transmission being selected to provide the desired power levels, device performance, and user experience.

As used herein, a “wireless power transmitter” or “transmitter device” includes any device (or component(s) of a device) capable of sending wireless power that can be received and recovered by a suitable receiver device. Similarly, a “wireless power receiver” or “receiver device” includes any device (or component(s) of a device) capable of receiving wireless power from a remote transmitter device and utilizing that power to operate one or more components of the receiver device (e.g., to power at least one amplifier of a playback device). In various examples, a single playback device (or other device) can be both a wireless power transmitter and a wireless power receiver, while in other examples a particular device may be only a transmitter device or only a receiver device.

In various examples disclosed herein, such wireless power transfer can include mid- or long-range wireless power transfer. As used herein, mid- and long-range wireless power transfer includes wireless power transfer over a distance of greater than about 10 cm, or in some examples greater than about 50 cm or greater than about 1 m. For example, in some instances a wireless power transmitter device and a wireless power receiver device can be separated from one another by at least about 10 cm, at least about 50 cm, or at least about 1 m during wireless power transfer.

As noted elsewhere herein, such mid- or long-range wireless power transfer technologies include radiative techniques (e.g., lasers, radio waves, microwaves, or other such propagation of electromagnetic radiation from the transmitter device towards the receiver device). In various examples, the wireless power receiver in such instances can include a photovoltaic cell, a diode, an antenna (e.g., a rectenna), or other suitable hardware that can convert electromagnetic radiation into electrical energy. Similarly, the wireless power transmitter in such instances can include an optical source such as a laser, a microwave source, an antenna (e.g., directional antennas, phased array antennas, etc.), or other suitable source of electromagnetic radiation.

Additionally or alternatively, such mid- or long-range wireless power transmission can include non-radiative transmission such as electromagnetic coupling (e.g., inductive coupling, resonant inductive coupling, capacitive coupling, resonant capacitive coupling, magnetodynamic coupling, etc.). In such instances, both the wireless power transmitter and the wireless power receiver can include electrically conductive coils (e.g., in the case of inductive coupling), electrodes (e.g., in the case of capacitive coupling), or rotating armatures carrying magnets thereon (e.g., in the case of magnetodynamic coupling).

a. Suitable Wireless Power Transfer Device Components

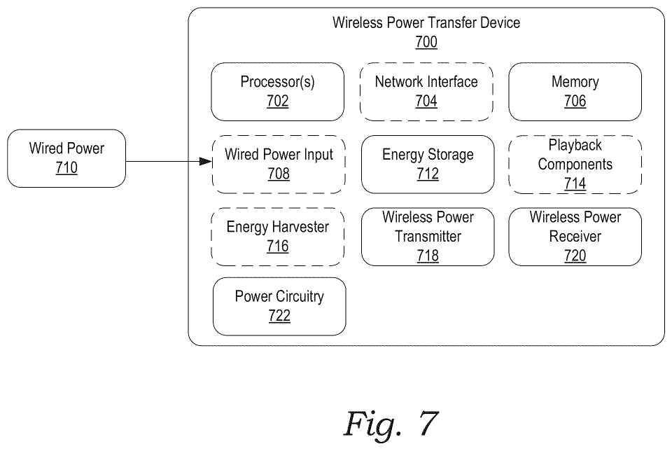

FIG. 7 is a schematic block diagram of a wireless power transfer (WPT) device 700. In some examples, the device 700 can be coupled to, integrated into, or included within a playback device (e.g., playback device 110a of FIG. 1C), an NMD (e.g., NMD 120a of FIG. 1F), or other suitable device.

Referring to FIG. 7, the WPT device 700 includes one or more processors 702, a network interface 704, and memory 706. These can be similar to, identical to, or include, processors 112a, network interface 112d, and memory 112b described above with respect to FIGS. 1C and 1F. In various examples, the wireless power transfer device 700 can include any or all of the features of playback device 110a or NMD 120a described previously herein. In some examples, the network interface 704 can include one or more transceivers that are configured to communicate via at least one WIFI network, and/or at least one BLUETOOTH network.

WPT device 700 optionally includes a wired power input port 708 that is configured to be electrically coupled to wired power 710 (e.g., via 110/220V wall power, a USB-C charger, etc.), such as an AC power port or a USB port (e.g., a USB TYPE-A port, a USB TYPE-B port, a USB TYPE-C port, etc.). The power input port 708 can be coupled (e.g., via cable) directly to a household power outlet (e.g., to receive alternating current (AC) power) or indirectly via a power adapter (e.g., a device that converts the AC power from the household power outlet to direct current (DC) power). In some examples, the wired power input port 708 is omitted, and the WPT device 700 operates solely on the basis of power received wirelessly from external transmitter device(s) and/or energy generated via energy harvester(s) 716.

The WPT device 700 further includes an energy storage component 712, which can take the form of a rechargeable battery, a capacitor, a supercapacitor, or any other suitable component that can store energy. The energy storage component 712 can be configured to store energy and to facilitate operation of the device (e.g., powering one or more amplifiers of a playback device). In this regard, the energy storage component 712 can be a battery that has a chemistry that facilitates recharging the battery, such as lithium-ion (Li-ion), nickel-metal hydride (NiMH), nickel-cadmium (NiCd), etc. The battery can be sized such that the processor(s) 702 and other components of the WPT device 700 can operate on battery power alone for an extended amount of time without the battery needing to be recharged. For example, the battery can have a 20 watt-hours (Wh) capacity that facilitates continuous playback of audio for at least 4 hours on battery power alone. The battery can be charged using power from one or more other components in the device 700 (e.g., wired power input port 708, wireless power receiver 720, energy harvester 716, etc.).

As noted previously, in some examples, the wireless power device 700 can include audio playback components 714 (e.g., one or more transducers, audio processing circuitry, microphones, voice processing circuitry, etc.), and as such the WPT device 700 can include or be part of an audio playback device or a network microphone device as described elsewhere herein. In various examples, such an audio playback device can be a soundbar, a subwoofer, a headphone device, a hearable device, a portable audio playback device, an architectural playback device, or a video playback device

The WPT device 700 optionally includes one or more energy harvesters 716. Energy harvesters 716 may include those devices configured to derive power from energy sources in the environment (e.g., solar energy, thermal energy, wind energy, salinity gradients, kinetic energy, sound energy, etc.). For example, the energy harvesters 716 can include one or more photovoltaic cells configured to convert received light into a voltage. Any of a variety of energy harvesters 716 may be included in the WPT device 700. Examples of such energy harvesters include photovoltaic cells, thermoelectric generators, micro wind turbines, piezoelectric crystals, electroacoustic transducers, and kinetic energy harvesters.

The WPT device additionally includes a wireless power transmitter 718, a wireless power receiver 720, and power circuitry 722. In operation, the WPT device 700 can receive wireless power from an external transmitter device via the receiver 720, and can transmit wireless power to an external receiver device via the transmitter 720, with the power circuitry 722 controlling some or all of the functions associated with these operations.

The wireless power transmitter 718 can include any component or combination of components capable of transmitting wireless power to an external wireless power receiver device. Such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power transmitter 718 can transmit power via radiative techniques such as using lasers, radio waves, microwaves, or other such techniques involving propagation of electromagnetic radiation from the transmitter device towards the receiver device. In various embodiments, such electromagnetic radiation may be directional (e.g., directed towards one or more receiver devices) or omnidirectional (e.g., radiating in substantially all directions from the wireless power transmitter 718). In various examples, the wireless power transmitter 718 in such instances can include an optical source such as a laser, a microwave source, an antenna (e.g., directional antennas, phased array antennas, etc.), or any other source of electromagnetic radiation. In some instances, the wireless power transmitter 718 can include one or more steering components configured to direct, focus, or steer wireless power. Such steering components can include, for example, one or more lenses, mirrors, directional antennas, or other suitable components.

Additionally or alternatively, the wireless power transmitter 718 can be configured to transmit wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power transmitter 718 can include electrically conductive coils (e.g., in the case of inductive coupling), electrodes (e.g., in the case of capacitive coupling), rotating armatures carrying magnets thereon (e.g., in the case of magnetodynamic coupling), or any other suitable structure capable of receiving power wirelessly via electromagnetic coupling.

The wireless power receiver 720 can include any component or structure configured to receive power wirelessly (e.g., via inductance, resonance, radiation, etc.) from an external wireless transmitter device. As noted previously, such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power receiver 720 can receive power via radiative techniques such as lasers, radio waves, microwaves, or other such techniques involving propagation of electromagnetic radiation from the transmitter device towards the receiver device. The wireless power receiver 720 in such instances can include an optical receiver such as a diode, a photovoltaic cell, an antenna (e.g., a rectenna), or other suitable hardware that can convert electromagnetic radiation into electrical energy.

Additionally or alternatively, the wireless power receiver 720 can be configured to receive wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power receiver 720 can include electrically conductive coils (e.g., in the case of inductive coupling), electrodes (e.g., in the case of capacitive coupling), a rotating armature carrying a magnets thereon (e.g., in the case of magnetodynamic coupling), or any other suitable structure capable of receiving power wirelessly via electromagnetic coupling.

With continued reference to FIG. 7, the WPT device 700 can include power circuitry 722 configured to receive power from the energy storage component 712, the wired power input 708, and/or the wireless power receiver 720, and, using the power obtained therefrom, drive an amplifier and/or a electroacoustic transducer with an audio output based on source audio. The power circuitry 722 can be configured to perform any of a variety of power-related tasks including, for example, one or more of the following: (1) power conversion (e.g., AC-AC conversion, AC-DC conversion, DC-AC conversion, and/or DC-DC conversion); (2) power regulation; (3) battery charging; and/or (4) power monitoring (e.g., battery monitoring). Examples of electrical components that may be integrated into the power circuitry 722 include transformers, rectifiers, inverters, converters, regulators, battery chargers, and/or power management integrated circuits (PMICs). In some examples, such power circuitry 722 can be integrated into either or both the wireless power transmitter 718 and the wireless power receiver 720.

In some examples, the power circuitry 722 can include battery circuitry that facilitates monitoring a state of a battery. In these examples, the battery circuitry can identify battery state information that includes information regarding one or more of the following battery states: a state-of-charge (SoC), temperature, age, and/or internal impedance. The battery circuitry can communicate the battery state information to, for example, the processor 702.

The power circuitry 722 can include regulation circuitry that facilitates converting a variable amount of voltage (e.g., a variable voltage from a battery, a variable voltage from an energy harvester, etc.) to a stable DC voltage. For example, the regulation circuitry can include switching regulator circuitry such as buck, boost, buck-boost, flyback, resonant, etc. switching regulator circuitry. The regulation circuitry can include one or more linear voltage regulators such as low-dropout (LDO) regulators. The regulation circuitry can be configured to output one or more fixed DC voltages (e.g., ±5V, ±12V) or AC voltages.

b. Wireless Power Group Examples

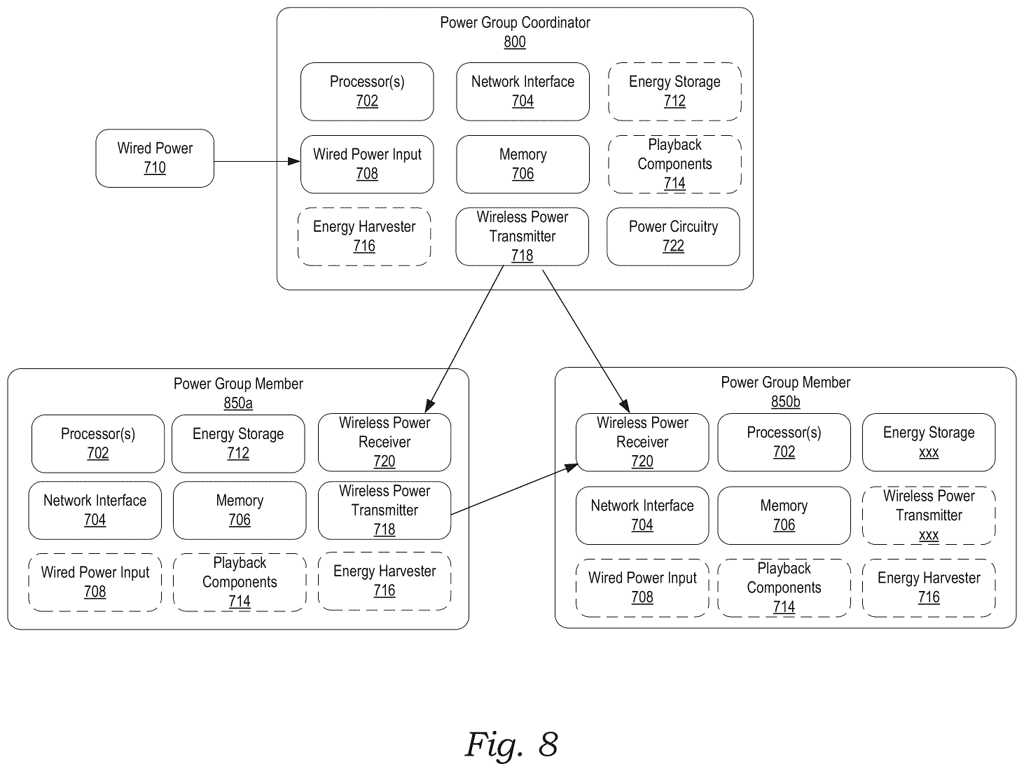

FIG. 8 shows interactions among a power group, which includes a plurality of WPT devices that can transfer power and/or data among one another. In the example shown in FIG. 8, the group includes a power group coordinator 800, and first and second power group members 850a and 850b. Each of the power group coordinator 800 and the power group members 850a and 850b can include some or all of the components described above with respect to the WPT device 700 of FIG. 7. In some examples, some or all of these devices can include or be audio playback devices. Although the illustrated group includes three devices, in various examples there may be one, two, four, five, or many more power group members (not shown).

As used herein, a “power group” can include two or more devices that are configured to wirelessly transfer power therebetween. In the illustrated example, the coordinator 800 transmits wireless power (e.g., via wireless power transmitter 718) to each of the first power group member 850a and the second power group member 850b. Additionally, the first group member 850a transmits wireless power to the second power group member 850b. In alternative examples, the power group coordinator 800 may transmit wireless power to fewer than all members of the wireless power group, with one or more group members 850 transmitting power to other group members 850 such that each device of the group receives or transmits wireless power to or from at least one other device of the group.

In the illustrated example, the power group coordinator 800 does not include a wireless power receiver 720, and it is connected to wired power 710. However, in other instances the power group coordinator 800 may have no connection to wired power 710, and may itself only be powered via wireless power transmission and/or energy harvesting. In some examples, one or more of the power group members 850 may be connected to wired power instead of or in addition to receiving wireless power from other group members.

As used herein, a “power group coordinator” can include a wireless power transfer device that is configured to transmit instructions to one or more power group members to initiate, cease, or modulate wireless power transmission therebetween. For example, a power group coordinator may cause the first power group member 850a to initiate wireless power transmission to the second power group member 850b. As described in more detail elsewhere herein, in some examples wireless power transmission may be initiated, ceased, or modified based on a number of parameters (e.g., a battery level of a device, a level or rate or wireless power received at a device, audio playback levels, etc.). In some examples, such parameters may be determined by or transmitted to the power group coordinator 800, which may then determine any appropriate modifications to wireless power transfer within the group, and may transmit instructions to group members accordingly.

In at least some instances, there may be no power coordinator. In such cases, each wireless power transfer device may independently determine whether, how, and when to transmit or receive wireless power from any external transmitter or receiver devices.

As noted previously, in some examples a plurality of audio playback devices can be grouped together for synchronous audio playback (e.g., as a bonded zone). In such instances, one of the playback devices may be a coordinator of the group, and may transmit and receive timing information from one or more other devices in the group. In various examples, the power group may be identical to the audio playback group. Alternatively, the power group may differ at least in part from any audio playback grouping. In at least some examples, the power group coordinator 800 may also serve as an audio playback group coordinator. In such cases, the power group coordinator 800 may transmit timing data or other information to group members via a wireless network and/or via data incorporated into the wireless power signals, as described in more detail elsewhere herein. Alternatively, the power group coordinator 800 and the audio playback group coordinator may be different devices. In still other examples, the power group may be formed without any audio playback grouping taking place, in which case there may be no audio playback group coordinator.

### V. Example Systems and Methods of Schedule-Based Charging of Device Batteries

Systems and methods for charging energy storages (e.g., batteries of playback devices associated with a media playback system) based on scheduling information are disclosed. Using the disclosed systems and methods the media playback system can employ one or more schedule-based charging schemes, for each battery of one or more playback devices, which reduce battery degradation and extend battery life as compared to conventional approaches. A media playback system may comprise one or more playback devices, including at least one playback device (e.g., a portable device) having its own energy storage (e.g., battery) and an accompanying power source, such as a portable USB charger plugged into an outlet, a wireless charging cradle, a wireless energy transfer system configured to wirelessly charge one or more devices, energy harvesting component, etc. configured to charge the energy storage in accordance with one or more charging schemes. In a conventional system each energy storage is typically charged to a maximum charge capacity of the energy storage as quickly as the hardware and power source will allow. The inventors have observed that dynamically adjusting a maximum charge threshold of a device based on scheduling information extends battery lifetime and, therefore, the service lifetime of the playback devices. For example, charging devices to one charge threshold while connected to an external power source and to another (higher) charge threshold in anticipation of being disconnected from the external power source reduces damage to the energy storage system of the device. As another example, charging devices to one charge threshold while connected to an external power source while one or more users are around (e.g., at home, in an office setting, etc.) and to another (lower) charge threshold while its user(s) is/are away for a substantial period of time (e.g., on a prolonged vacation) similarly reduces potential damage to the energy storage system of the device. Thus, changing a device's maximum charge threshold (e.g., raising or lowering the maximum charge threshold) to account for when and how the device is used (or is likely to be used) can significantly reduce damage to the device and prolong its usefulness. Techniques for adjusting a playback device's maximum charge threshold based on scheduling information, such as calendar events, are disclosed. The disclosed media playback system provides alternative charging schemes configured to reduce degradation and prolong usefulness of the energy storages and corresponding playback devices as compared to conventional techniques.

Energy storages (e.g., batteries) can be charged to any number of charge thresholds (i.e., percentages of storage capacity or state of charge (SOC)), such as 10%, 15%, 25%, 75%, and so on. Devices that typically reside on a charging base or are otherwise being supplied power from an external source (i.e., “while connected”) can be configured to have a low maximum charge threshold (e.g., 20%, 30%, 40%, etc.) during normal operation because the device can rely on power supplied by the external power source during playback, for example. However, if a user would like to use the device away from the charging base or power source (i.e., “while disconnected”), the maximum charge threshold can be increased (e.g., to 90%) to meet the user's needs. For example, a user planning an outdoor event, such as a beach party, will likely want the device charged to a higher charge threshold to ensure that the device will be available for the duration of the event. Accordingly, the media playback system can adjust the maximum charge threshold of the device to 90%, for example, to accommodate the event and the user's needs. This higher maximum charge threshold may be based on any number of factors relating to the device and event data including, for example, the start time of the event, the end time of the event, the duration of the event, the type of event, one or more users associated with the event, past event usage information, location of the event, the rate at which the device typically consumes energy, and so on. The device can be charged to a particular maximum charge threshold (and at a particular charge rate) by, for example, setting or adjusting its maximum charge threshold to ensure that the device will have adequate energy resources for the event and, therefore, adequate playback time when the device is needed. In this manner, the playback device can be configured to be charged to a low charge threshold (e.g., 25%) while connected to an external power source and a higher charge threshold (e.g., 75%) in anticipation of being used while not connected to an external power source. Thus, the playback device (and its battery) can primarily be charged to the low charge threshold rather than a higher and potentially unsafe threshold, thereby reducing damage to the battery of the playback device and prolonging the life of the battery and playback device.

In some cases, the media playback system uses scheduling information to determine when a device's maximum charge threshold can be lowered. For example, if a user is going on vacation and is not taking a particular portable playback device, that device's maximum charge threshold may be lowered to prolong the life of the battery and then raised (e.g., to its standard or normal maximum charge threshold), for example, just prior to the user's expected or scheduled return (e.g., thirty minutes, one hour, an estimated amount of time it takes to get the battery charged to a predetermined threshold), the end of the vacation, when context awareness information indicates that a person or people are nearby or home again, and so on. In this manner, the disclosed schedule-based charging scheme prolongs the life of the battery and corresponding playback device as compared to conventional systems.

In some embodiments, the media playback system uses calendar events from one or more electronic calendars as a source for scheduling information. Calendar events can include any type of suitable information including, for example, a title, a start time, an end time, a list of one or more hosts, a list of one or more invitees (invited guests), a list of one or more attendees (confirmed guests), location information (e.g., an address, Global Positioning System (GPS) coordinates, etc.), free form notes, playlists and corresponding metadata, etc. The media playback system may identify calendar events via any number of techniques, such as scanning electronic calendars, receiving calendar events from one or more users, imputing or inferring events from past usage information and/or other events/context information, and so on. As another example, individual playback devices may be assigned or otherwise associated with individual calendars that users and/or the media playback system can use to schedule the use of playback devices. Accordingly, the disclosed media playback system uses both direct and indirect methods to identify and associate calendar events with a playback device.

In some cases, a user may grant the media playback system access to one or more calendars, such as a personal calendar, that the media playback system can use to search for and identify relevant calendar events (i.e., calendar events that are likely to result in an adjustment of the device's maximum charge threshold). For example, an application component of the media playback system may prompt a user to grant the application access to the user's electronic calendars or provide its own calendar service to which the user can add events. In some cases, the media playback system manages a calendar for one or more devices and allows users to “invite” playback devices to events as, for example, a “Calendar Resource.” For example, a user may “invite” a playback device to an event by sending an electronic invitation to the media playback system identifying the device, adding an event to a calendar associated with the device, via voice command (e.g., “Hey Sonos Move, get ready for the BBQ on Saturday afternoon.”)

In some cases, the media playback system searches for particular keywords or key phrases in the scheduling information, such as “party,” “vacation,” “beach,” “outdoor,” “soirée,” “boating,” “camping,” “road trip,” etc., that may correspond to relevant calendar events. A search of keywords can trigger a corresponding charging optimization profile such that the device will be fully or substantially fully charged a predetermined time (e.g., 1 hour, 6 hours, 12 hours, 24 hours) before the event begins. In response to the media playback system identifying a calendar event that includes one or more of these keywords, the media playback system may configure one or more playback devices to be charged to a higher maximum charge threshold prior to the event so that the playback device(s) can be used throughout the event (or for as much time as the battery will allow). Such a list of keywords can be provided by any number of sources, such as manufacturers, users, crowdsourcing resources, machine learning techniques, and so on.

Alternatively, or in addition to keyword searches, the media playback system can include and/or train a machine learning-based classifier to determine, for each of a number of calendar event and playback device pairs ({calendar event, playback device}), the probability that the maximum charge threshold of the playback device should be modified (increased or decreased) in anticipation of the corresponding calendar event. For example, the duration of an event that includes the text “Flight to New York” is more likely to be associated with a pair of portable headphones than an out-loud playback device intended to provide sound to an entire room. As another example, the duration of an event that includes the text “House Party in New York! !” is more likely to be associated with the out-loud playback device intended to provide sound to an entire room than the pair of headphones. If that probability exceeds a predetermined threshold (e.g., 50%, 70%, 90%), the media playback system can flag the corresponding calendar event as a relevant event for the corresponding playback device.

The classifier may be any of a variety or combination of classifiers including neural networks such as fully-connected, convolutional, recurrent, autoencoder, or restricted Boltzmann machine, a support vector machine, a Bayesian classifier, and so on. When the classifier is a deep neural network, the training results in a set of weights for the activation functions of the deep neural network. A support vector machine operates by finding a hyper-surface in the space of possible inputs. The hyper-surface attempts to split the positive examples (e.g., feature vectors for photographs) from the negative examples (e.g., feature vectors for graphics) by maximizing the distance between the nearest of the positive and negative examples to the hyper-surface. This step allows for correct classification of data that is similar to but not identical to the training data. Various techniques can be used to train a support vector machine. In some cases, the media playback system similarly uses machine learning techniques to construct, for example, a predictive model (e.g., a forecast model, time-series model, etc.) that predicts when and how long a playback device will be used at an event, how much charge will be required by that use, and so on.

Adaptive boosting is an iterative process that runs multiple tests on a collection of training data. Adaptive boosting transforms a weak learning algorithm (an algorithm that performs at a level only slightly better than chance) into a strong learning algorithm (an algorithm that displays a low error rate). The weak learning algorithm is run on different subsets of the training data. The algorithm concentrates more and more on those examples in which its predecessors tended to show mistakes. The algorithm corrects the errors made by earlier weak learners. The algorithm is adaptive because it adjusts to the error rates of its predecessors. Adaptive boosting combines rough and moderately inaccurate rules of thumb to create a high-performance algorithm. Adaptive boosting combines the results of each separately run test into a single, very accurate classifier. Adaptive boosting may use weak classifiers that are single-split trees with only two leaf nodes. A neural network model has three major components: architecture, cost function, and search algorithm. The architecture defines the functional form relating the inputs to the outputs (in terms of network topology, unit connectivity, and activation functions). The search in weight space for a set of weights that minimizes the objective function is the training process. In one embodiment, the classification system may use a radial basis function (“RBF”) network and a standard gradient descent as the search technique.

In some cases, the media playback system may impute or infer relevant events from information available to the media playback system, such as past usage information, information about other events, contextual information (e.g., weather information, power information, etc.). For example, if a user regularly uses a playback device via battery power (e.g., while not plugged into a power outlet) at certain times (e.g., 7 am to 8 am every weekday morning, 9 pm to 10 pm every night, 10 pm to lam on Friday nights/Saturday morning, etc.), the media playback device can identify those times as relevant events whether or not there are any corresponding calendar events associated with those time frames. Moreover, in the event that there is a calendar event associated with those time frames, the media playback system can use any information or metadata associated with those calendar events to identify additional keywords to use to identify relevant events, thereby enhancing the keyword lists over time. As another example, if inclement weather is in the forecast, such as a storm warning or other conditions that may result in a loss of power (e.g., scheduled power outages, construction projects, etc.), the media playback system can identify the forecasted duration of the problematic conditions as a relevant event (i.e., an event for which the maximum charge threshold of the device may be adjusted) and charge one or more playback devices in anticipation of the event. In this manner, the playback device will be ready to use in emergency and non-emergency situations should the power go out. In this manner, the media playback system uses information from third parties (e.g., weather services, utility companies, government agencies, building management companies, and so on) for purposes of identifying relevant events.

In some cases, an event may be associated with conflicting or overlapping events. In these cases, the media playback system may attempt to ensure that the device has enough energy to accommodate each of the events or the event with the greater energy requirements. Alternatively, the media playback system may select one of the events and configure the device to be charged for that event. The media playback system may make this determination, for example, based on a hierarchy of users and/or event information (e.g., who is hosting the event, who is attending the event, and so on), a weighted vote of users, event location, event priority, etc. As another example, the media playback system may use a “default state of charge” value corresponding to a predetermined maximum safe charge level (e.g., an acceptable safe maximum threshold) for a device so that the device is charged with as much energy as possible while causing less damage to the battery than a full charge. In some cases, the media playback system may prompt one or more users to select an event from among a group of conflicting events and/or to update the scheduling information. In some cases, after a playback device has been disassociated with an event due to a conflict or denial by a user, the media playback system may attempt to identify another device that may be used instead and associate any identified device with the event so that the device can be charged in anticipation of the event (which may be subject to user approval). Furthermore, individual devices can be associated with one or more users so that only calendar events associated with that user (or group of users) affect the charging scheme for those devices while calendar events that are not associated with that user (or users) do not affect the charging scheme of those devices. Similarly, particular zones or groups of devices may be associated with one or more users such that devices in those zones or groups are only affected by the calendars of the user(s) associated with those zones or groups.

A device that is attached to or integrated with an energy harvesting component (e.g., solar, radio frequency (RF), induction, mechanical energy harvesting (e.g., piezoelectric, vibration, torsion, etc.), thermodynamic energy harvesting (e.g., heat, chemical reaction, etc.), and so on) can use weather information or other factors (e.g., sunrise and sunset times, ultraviolet (UV) index, and so on) as a basis for establishing a maximum charge threshold for the device. For example, if a playback device with a solar panel is scheduled to be used outdoor during daylight hours on a sunny day, the media playback system may set a maximum charge threshold to 80% in anticipation of the scheduled event but to 95% if the event is at night or takes place while cloud cover is in the forecast. Thus, the media playback system can adjust maximum charge thresholds to account for potential opportunities to harvest energy from alternative sources.

In some cases, once a relevant event is identified, the media playback system can configure one or more playback devices to be charged in anticipation of the relevant event by increasing or decreasing a maximum charge threshold of the playback device(s). In other cases, after the media playback system identifies relevant events for each of one or more playback devices the media playback system prompts one or more users prior to assigning or otherwise associating an event with a playback device. For example, the media playback system can prompt one or more users via an audible or text-based notification from (or on) one or more playback devices, an email, a text message, an app alert/notification, a voice message (e.g., computer-generated), an audible tone or set of tones, etc. to confirm or reject the playback device's association with the event. In some cases the media playback system maintains a user-designated hierarchy of users and bases the decision to associate or not associate a playback device with a calendar event based on the response from the responding user with the highest rank. In some cases, the media playback system bases the decision on a weighted vote of one or more users using, for example, user-assigned weights. In this manner, the media playback system can resolve conflicts regarding usage of playback devices. Moreover, the decision to associate or not associate a playback device with an event can be fed back to the media playback system classification system to improve the classification system over time. For example, if associations between events identified as relevant based on a particular keyword or keywords are often denied, the media playback system can remove that keyword (or those keywords) from its list of keywords used to find relevant events. In this manner, the media playback system dynamically adapts to user needs and preferences over time to enhance the media playback system's ability to charge devices based on scheduling information, thereby enhancing and prolonging battery life as compared to conventional systems.

After a calendar event is associated with a playback device, the media playback system uses information about the calendar event to determine or estimate how much energy the playback device will need for the event and when. In some cases, the media playback system obtains average or typical energy dissipation rates from, for example, the device itself, a manufacturer, device expert, crowdsourced materials, etc. to determine how much energy the device will need for the event based on the duration of the event. In some cases, the media playback system can analyze usage statistics for the device to determine an average energy dissipation rate for the device and multiply that value by the duration of the event to establish a baseline energy requirement for the device during the event. If the determined baseline energy requirement is above or within a predetermined threshold below the current maximum charge threshold of the playback device (e.g., within 5%, 15%, 30%, etc. of the current maximum charge threshold, within 100 mAh, 200 mAh, 350 mAh, etc. of the current maximum charge threshold, and so on) the playback device can be configured to be charged to a higher threshold by, for example, increasing the maximum charge threshold of the device.

For example, a playback device with a battery that has a storage capacity of 2500 mAh and that operates at, on average, at 250 mA, may be configured to be charged to a lower threshold of 20% of its capacity (or 500 mAh) while connected to an external power source. If the media playback system determines that the playback device is likely to be expected to be available for a five-hour event, the media playback system can determine or estimate how much energy will likely be necessary for the playback device to perform for the entirety of the event. In this example, a device that typically operates at 250 mA will likely need 5*250 (1250) mAh to operate for the duration of the five-hour event. Accordingly, the media playback system can adjust the maximum charge threshold of the device to 1250 mAh to increase the likelihood that the device will have enough energy for the event.

In some cases, the media playback system may further adjust the maximum threshold based on additional details of the event, such as who is using the device, the type of music being played by the device, the probability that the event will extend beyond the scheduled end time, and so on. The media playback system can use usage history to determine these values by, for example, identifying average dissipation rates for individual users or event keywords as compared to average or mean dissipation rates (e.g., distance or number of standard deviations away from the mean, etc.), applying machine learning techniques to details or information about the event and the device to determine or estimate how much energy (if any) the playback device will have at the end of the event, and so on. If an estimated amount of energy remaining at the end of the event is within a predetermined amount of a minimum threshold (e.g., 5% of storage capacity), the media playback system can further increase the maximum charge threshold up to a predetermined threshold (e.g., 90%, 95%, 97.5%) of the device's maximum storage capacity. In this manner, the media playback system can reduce the overall amount of time that a playback device is charged beyond an undesirable (e.g., unsafe) level while enabling the device to have enough energy to meet the demands of its users, thereby prolonging the usable life of the playback device as compared to conventional charging schemes.

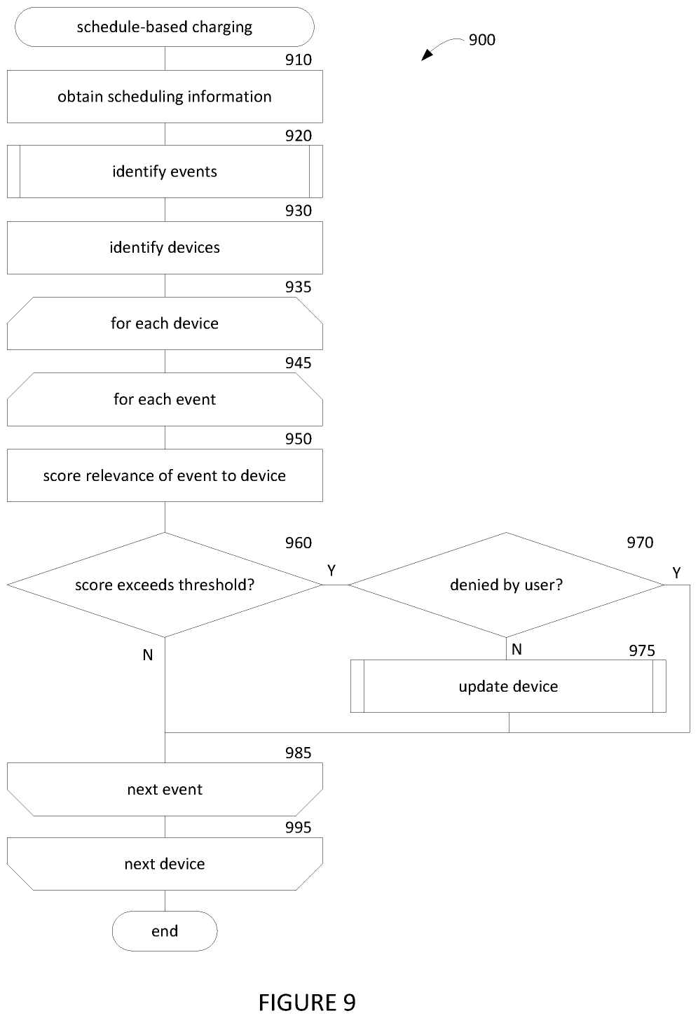

FIGS. 9-11 illustrate example methods in accordance with the present technology. The methods 900, 1000, and 1100 can be implemented by any of the devices described herein, or any other suitable devices now known or later developed. Various embodiments of the methods 900, 1000, and 1100 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 900, 1000, and 1100 and for other processes and methods disclosed herein, the flowcharts show functionality and operation of possible implementations of some embodiments. In this regard, each block may represent a component, a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 9-11 may represent circuitry that is wired to perform the specific logical functions in the process.

FIG. 9 illustrates an example method 900 for updating charging schemes of one or more playback devices based on scheduling information in accordance with some embodiments of the disclosed technology. With reference to FIG. 9, the method 900 begins at block 910, which involves the media playback system obtaining scheduling information by, for example, downloading calendar data, receiving calendar invites from one or more users or systems, obtaining contextual information, such as weather data, scheduling information from utilities (e.g., power company), etc. In block 920, the media playback system invokes an identify events component to identify events from the scheduling information. In block 930, the media playback system identifies devices with adjustable maximum charge thresholds or that may have their charging scheme changed based on the scheduling information. For example, the media playback system may identify devices by accessing a device roster or manifest associated with a group of playback devices. As another example, the playback system may identify playback devices that are in proximity to the media playback system based on a determination that the media playback system and the playback device are communicatively coupled via a common local area network, based on a determination that they are in direct wireless communication (e.g., Bluetooth, NFC, ultra-wideband (UWB), etc.), based on a received signal strength indicator (RSSI), based on an audible chirp emitted via one device and detection via one or more microphones of another device, or any other suitable approach.

In blocks 935-995, the media playback system loops through each of the identified devices to determine whether the device should have its charging scheme modified. In blocks 945-985, the media playback system loops through each of the identified events to determine whether the event is relevant to the device (i.e., if the event affects the charging scheme of the currently selected device). In block 950, the media playback system determines a score corresponding to the likelihood that the event is relevant to the device and will affect its charging scheme. For example, the media playback system counts the number of keywords associated with the event and compares the number of keywords to an “event keyword threshold” to determine a ratio or score corresponding to the likelihood that the event will result in the playback device needing more (or less) energy. In some cases, individual playback devices have an associated list of keywords that can be compared to keywords associated with the event. In these cases, the number of keywords the event and the playback device have in common can be compared to a “common keyword threshold” to determine a ratio or score corresponding to the likelihood that the event will result in the playback device needing more (or less) energy. For example, if an event includes the keywords “beach,” “party,” and “outdoor” and the playback device has a keyword list that includes “outdoor” and “party,” the event and the playback device have two keywords in common. If the common keyword threshold is four in this example, then the {event, playback device} pair would have a score of 2:4 or (0.5). As another example, the media playback system may employ a machine learning based classifier to attributes of the event (e.g., start time, end time, attendees, host, location, etc.) and the playback device (e.g., usage history, device type, device features) to estimate the likelihood that the event will result in the playback device needing more (or less) energy than its current maximum charge threshold for the event.

In decision block 960, if the determined score exceeds a predetermined threshold (e.g., 0.4, 0.9, 1.5, 5.0), then the media playback system continues at block 970, otherwise the media playback system continues at block 985. In some cases, the media playback system uses different thresholds at decision block 960 based on how the score was determined, such as a first threshold if the score was determined using a classifier, a second threshold if the score was determined by comparison to an “event keyword threshold,” a third threshold if the score was determined by comparison to a “common keyword threshold,” and so on. In other cases, the media playback system normalizes one or more scores prior to comparison to a threshold. In decision block 970, if the association between the currently selected playback device and the currently selected event is denied by a user, then the media playback system continues at block 985, otherwise the media playback system continues at block 975. For example, the media playback system may notify one or more users that it is considering associating an event with a playback device (potentially causing the charging scheme of the playback device to be modified) and prompt the user to allow or deny the association. As discussed above, the media playback system can use the users responses to these prompts to determine whether the association can move forward. Moreover, the media playback system can use the overall results as feedback to the above-mentioned classification and scoring schemes to improve those processes over time, such as feedback to a keyword association mechanism, feedback to a machine learning classifier, and so on. Similarly, the media playback system can monitor whether the devices associated with events are actually used at these events and provide this information to the classification and scoring schemes for improvement. Thus, the media playback system itself can provide feedback to the classification and scoring schemes, thereby improving these schemes without requiring user input.

In block 975, the media playback system invokes an update device component to modify the charging scheme of the currently selected device based on the currently selected event. In block 985, if there are any events remaining to be analyzed then the media playback system selects the next event and loops back to block 945 to analyze the next event, otherwise the media playback system continues at block 995. In block 995, if there are any devices remaining to be analyzed then the media playback system selects the next device and loops back to block 935 to analyze the next device, otherwise the method 900 completes.

One of ordinary skill in the art will recognize that any number of events may prompt the media playback system or a device to review and analyze scheduling information, such as receiving an indication that a calendar has been updated, receipt of a calendar invite, obtaining new contextual information, a manual request from a user, a notification that a device has been added or removed from a group of devices or area, an indication that a device has been associated with an event, etc. Similarly, the media playback system may periodically (e.g., hourly, daily, etc.) check for new scheduling information and/or the condition of playback devices to determine whether any changes to their charging schemes are warranted. For example, if the media playback device determines that a device is rarely used while disconnected from an external power source, the media playback system may gradually reduce the maximum charge threshold of that device to a minimum value.

Additionally, the media playback system can identify any conflicting events for individual devices and notify one or more users of the conflicting events and the availability of alternative devices. Furthermore, the media playback system can identify events for which more than a predetermined threshold number (e.g., 2, 4, 8) of devices or a predetermined threshold number (e.g., 1, 2, 5) of devices of a particular type are associated with an event and configured to be charged in anticipation of the event. In some cases, the media playback system may choose one or more of the devices to remain associated with the event and disassociate the other devices from the event. For example, if the media playback system determines that three Sonos Roams and three Sonos Moves are each associated with a particular event, the media playback system may remove one of the Sonos Roams and two of the Sonos Moves. The media playback system may use default predetermined threshold numbers of devices or devices of a certain type provided by a manufacturer, provided by one or more users, and so on. The media playback system may use any number of factors to determine which devices to disassociate with an event, such as the health of the device and/or its battery, the maximum charge level for the device's battery, the age of the device, usage history of the device, such as whether the device has been used at events with similar attributes (e.g., start times, location, users, etc.), and so on. Alternatively, the media playback system may select devices randomly. The media playback system may prompt one or more users to confirm or deny any event/playback associations or dis-associations.

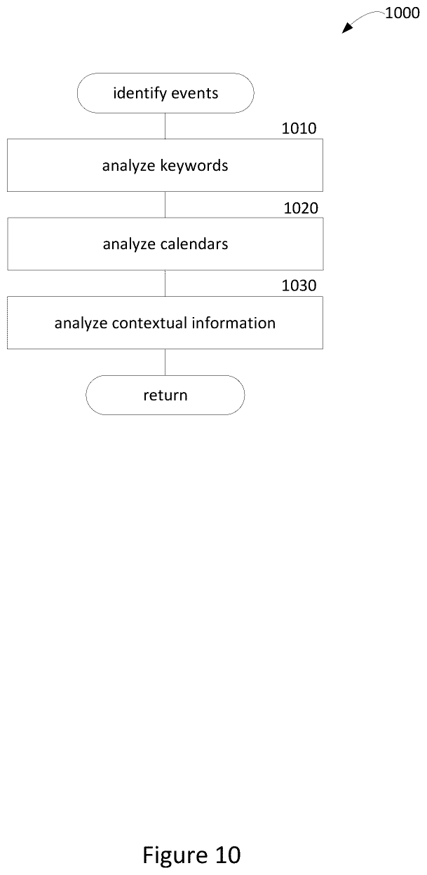

FIG. 10 illustrates an example method 1000 for identifying events based on scheduling information in accordance with some embodiments of the disclosed technology. With reference to FIG. 10, the method 1000 begins at block 1010, which involves analyzing keywords associated with scheduling information. In some cases, the media playback system maintains its own list of keywords that correspond to events that are or have been associated with changes in charging schemes for a playback device. In some cases, these keywords may be correlated with changes that result in the maximum charge threshold of a device being increased (e.g., “outdoor,” “camping,” “flight,” etc.) or decreased (“away,” “vacation,” “quiet,” etc.) The media playback system can maintain different lists of keywords for different types of devices. As an example, the keyword “flight” may be on a list of keywords correlated with increasing the maximum charge threshold of a pair of headphones but on a list correlated with decreasing the maximum charge threshold of a large, portable out-loud playback device. Furthermore, these lists can be customized by users and/or updated by the media playback system itself, such as in response to an indication that a device associated with an event was or was not used at the event. Additionally, the media playback system can obtain keyword lists from manufacturers, crowdsourcing services, etc.

In block 1020, the media playback system analyzes calendars associated with the media playback system and individual playback devices to identify any events for which one or more playback devices have been invited as a “Calendar Resource.” In some cases, the media playback system can extend any “invitations” to other devices that are bonded, paired, and/or grouped with an “invited” device and/or prompt one or more users to let the user know of any relevant pairings/groupings. In this manner, the media playback system can ensure that devices that are known to have been paired or otherwise grouped together can be charged sufficiently to work in concert for any upcoming events. For example, if two or more devices are regularly paired to work in tandem to provide stereo or surround sound and only one of the devices is associated with a particular event, the media playback system can extend an invitation to the other device to ensure that it will be sufficiently charged for the event.

In block 1030, the media playback system analyzes contextual information to impute or infer events from the available information. For example, the media playback system can analyze weather forecasts and trends to determine when power to a device may be lost, such as due to a power outage caused by severe winds and/or thunderstorms, scheduled blackouts caused by electric utilities, and so on. The media playback system can use this information to generate “no power events.” The media playback system can use these events to both determine whether a device should be charged in anticipation of the “no power event” and to avoid relying on the ability to charge devices during these events.

As mentioned above, some playback devices may have integrated energy harvesting systems, such as a solar panel, kinetic energy harvesting system, etc. The media playback system can use weather information and usage statistics to determine when these energy harvesting systems are likely to be able to harvest energy (and for how long). For example, the media playback system can prompt one or more users to place a device in a well-lit area when sun is in the forecast and rely on the solar panels as its method of charging rather than relying on power provided by another source. Moreover, the media playback system can generate a “solar charge event” that can be associated with the device indicating when the device may be charged using solar energy. In this manner, the scheduling information allows the media playback system to reduce costs to the user and reduce its burden on the local power grid, thereby benefiting both the user in terms of electricity costs and the public in terms of available power.

As another example, the media playback system may obtain “Time of Use” rates from a utility company to determine the cost of consuming energy at different times of the day/week, such as “on peak” rates, “off peak” rates, “super off peak” rates, and so on. The media playback system can use these rates to determine whether a device can be charged during a lower priced period in anticipation of an event. If so, the device can be configured to be charged in anticipation of an event during the lower priced period to conserve resources. Additionally, the media playback system can generate corresponding “on peak” events, “off peak” events, “super off peak” events and associate these events with one or more playback devices (e.g., by adding the event to a calendar associated with the one or more playback devices) so that the media playback system and/or the devices can use this information as a basis for determining when to charge a device. In this manner, the media playback system can reduce degradation of the device battery without burdening the user with increased costs as compared to typical charging schemes. After analyzing the contextual information method 1100 returns any obtained or generated event information.

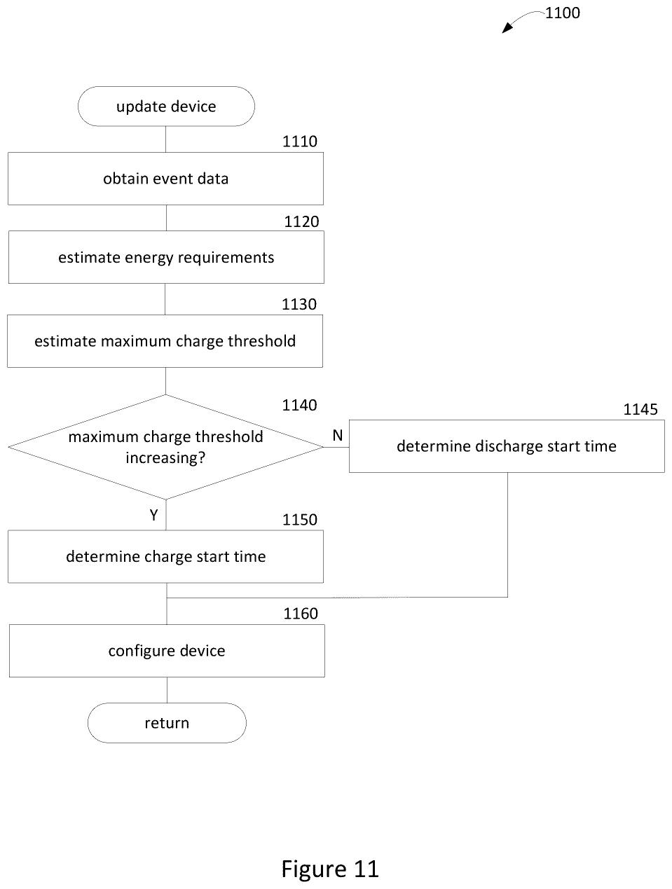

FIG. 11 illustrates an example method 1100 for updating a charging scheme for a device based on scheduling information in accordance with some embodiments of the disclosed technology. With reference to FIG. 11, the method 1100 begins at block 1110, which involves obtaining event data, such as when the event starts, the duration of the event, the type of event, and so on. This information may be obtained during the identify event block 920 and corresponding method 1000 described above with respect to FIG. 10. In some cases, the media playback system may retrieve updated information from a corresponding calendar (or calendars), from a user, etc. In block 1120, the media playback system estimates energy requirements for the currently selected device and currently selected event based on typical usage rates of the device and the duration of event. If the device is bonded, paired, and/or grouped with one or more other devices (e.g., a bonded zone type, such as stereo pair, home theater multichannel audio (5.1, 5.x, 7.1.2, 7.2.4, 9.2.4, 9.4.6, etc.), and so on, the media playback system may take this into account by determining typical usage rates while the device is paired or grouped with those devices. In some cases, the media playback system may prompt one or more users to confirm whether the other device(s) will be paired with the currently selected device during the event. If energy consumption by a first device is reduced while the first device is paired with another device because the first device is able to offload certain responsibilities to the other device (e.g., playback of certain bass frequencies, coordination responsibilities, operating a voice engine, playback analysis, etc.), the media playback system can use the reduced energy consumption rate as a basis for estimating how much energy the first device will use during the event if the first device will be paired with the second device during the event.

In block 1130, the media playback system estimates a maximum charge threshold for the currently selected device and the currently selected event. In some cases, the estimated maximum charge threshold is based on a simple increase of the estimated energy requirements (if possible), such as 110%, 120%, 150%, etc. so that the playback device will have at least as much energy as is estimated plus some additional energy to account for potential changes in the event (earlier start, longer than expected), errors in the estimation of energy requirements, unexpected usage levels, etc. In some cases, the estimated maximum charge threshold is based on the estimated energy requirements and additional details related to the device and the event, such as usage statistics, who will be at the event, how and where the device will be used, etc. For example, the media playback system can use usage statistics to determine whether individual users typically use playback devices at higher or lower rates of energy consumption than average and adjust the maximum charge threshold accordingly (e.g., set the maximum charge threshold higher than the estimated energy requirements for users who typically require more energy and lower than the estimated energy requirements for users who typically require less energy). For example, events that include the keyword “outdoor” or that are hosted by a particular user may tend to involve the use of playback devices at higher volumes, thereby using the playback devices at higher rates of energy consumption and requiring additional energy.

As another example, the media playback system can use usage statistics to determine whether individual playlists or types of media typically result in the use of playback devices at higher or lower rates of energy consumption than average and adjust the maximum charge threshold accordingly (e.g., set the maximum charge threshold higher than the estimated energy requirements for media or playlists that require more energy and lower than the estimated energy requirements for media or playlists that require less energy). For instance, spoken word content (e.g., podcasts, talk radio, sports, social audio, etc.) may be expected to have significantly less low frequency content (which typically requires more energy) than audio associated with music and/or video content. Thus, the media playback system can assign “energy offset” factors (positive or negative) to individual users, playlists, event location, etc. that the media playback system uses to adjust the estimated maximum charge threshold for the device. The media playback system generates these factors by comparing average energy consumption rates for the devices to actual energy consumption rates for individual events and users. For example, if a user typically uses devices at energy consumption rates that are 25% above average, the media playback system can assign an energy offset factor of 25% or 0.25 to the user and take that offset into account when estimating maximum charge thresholds for events associated with that user by increasing the estimated maximum charge threshold by 25%. Furthermore, users can adjust these energy offset factors to suit their needs. In some cases, the estimated energy requirements or estimated maximum charge threshold may be greater than an acceptable safe maximum threshold for a device. If so, the media playback system can set the maximum charge threshold to the acceptable safe maximum threshold for the device. Additionally, the media playback system can recommend another device with additional energy storage or prompt the user to select another device in response to determining that the estimated energy requirements or estimated maximum charge threshold exceeds the acceptable safe maximum threshold for a device.

In decision block 1140, if the maximum charge threshold of the currently selected device is decreasing (i.e., if the estimated maximum charge threshold is less than the currently selected device's current maximum charge threshold), then the media playback system continues at block 1145, otherwise the media playback system continues at block 1150. In block 1145, because the maximum charge threshold of the device is decreasing (e.g., because the associated user(s) are going on vacation or are otherwise expected to be away) the media playback system determines a discharge start time for the device (i.e., the time at which the device should have its maximum charge threshold adjusted to the estimated maximum charge threshold), such as the start time of the currently selected event, a predetermined period of time prior to that start time, etc.

In block 1150, the media playback system determines a charge start time for the currently selected device and currently selected event based on at least the device's current maximum charge threshold, the estimated maximum charge threshold, historic charge rates for the device, a start time of the event, and/or contextual information, etc. The media playback system uses the device's current maximum charge threshold and the estimated maximum charge threshold to determine a delta charge level corresponding to the amount of additional charge needed to increase the device's charge level to the estimated maximum charge threshold. The media playback system can divide this delta charge level by historic average charge rates for the device to estimate the amount of time (“charge time”) it will take to bring the device to the estimated maximum charge level at historic charge rates for the device. After the charge time is determined, the media playback system can subtract the charge time from the start time to establish a time to start charging the device. Alternatively, the media playback system may subtract the charge time from a time other than the start time, such as the time an associated user typically leaves the location at which the device is typically stationed, a time that accounts for any commute between the location at which the device is typically stationed and a location associated with the event, a predetermined time designated by a user (e.g., 8 am, noon, 5 pm), and so on.

In some cases, the media playback system may notify a user that the media playback system is configuring the device to be charged by the determined start time and allow the user to adjust that time based on their needs and availability. Additionally, the media playback system may schedule the device to be charged during times when the device can take advantage of energy harvesting systems associated with the device and/or any periods of reduced energy costs (e.g., “off peak” or “super off peak”). Furthermore, the media playback system can notify or alert the user to connect the device to a charger prior to the charge start time and/or to take the device with the user prior to leaving. For example, the media playback system may alert a user via an audible or text-based notification from (or on) the playback device, an email, a text message, an app alert/notification, a voice message (e.g., computer-generated), etc. if the device is not connected to a charger at or near the determined charge start time. If the media playback system has access to a calendar associated with a user (such as the host of the event or the owner of the device), the media playback system can add one or more events to the user's calendar reminding the user to charge the device, bring the device with the user, and so on. The reminders may include details about the device to help the user determine which device to charge/take if there are multiple available devices, such as an image of the device, the location of the device, a name associated with the device, such as a nickname provided by the user, and so on. The device itself may be configured to alert the user by way of an audio or visual cue at one or more predetermined periods (e.g., thirty minutes, one hour) before the event or before the user is expected to leave for the event.

In block 1160, the media playback system configures the playback device to be charged to the estimated maximum charge threshold starting at the determined charge start time (or to set its maximum charge threshold to the estimated maximum charge threshold at the determined discharge start time). In addition to configuring the charging scheme of the device, the media playback system may also configure other aspects of the playback device. For example, the media playback system can configure the playback device to automatically pair or bond with any other devices or zones associated with the event at the start time of the event, to switch from a WiFi to a Bluetooth connection at the start time of the event, and so on. The media playback system can further configure the device to revert to its original maximum charge threshold and other settings after the event is over, such as at the scheduled end time of the event, when the device has been reconnected to power, when the device is returned to its original location, etc. If the device is paired or bonded with one or more other devices or zones that are not associated with the event, the media playback system may also reconfigure the associated devices or zones to adapt to the absence of the device during the event. For example, if the device performs certain responsibilities with respect to a surround sound configuration of speakers, the media playback system can configure the device to offload those responsibilities to other devices in the configuration before the event.

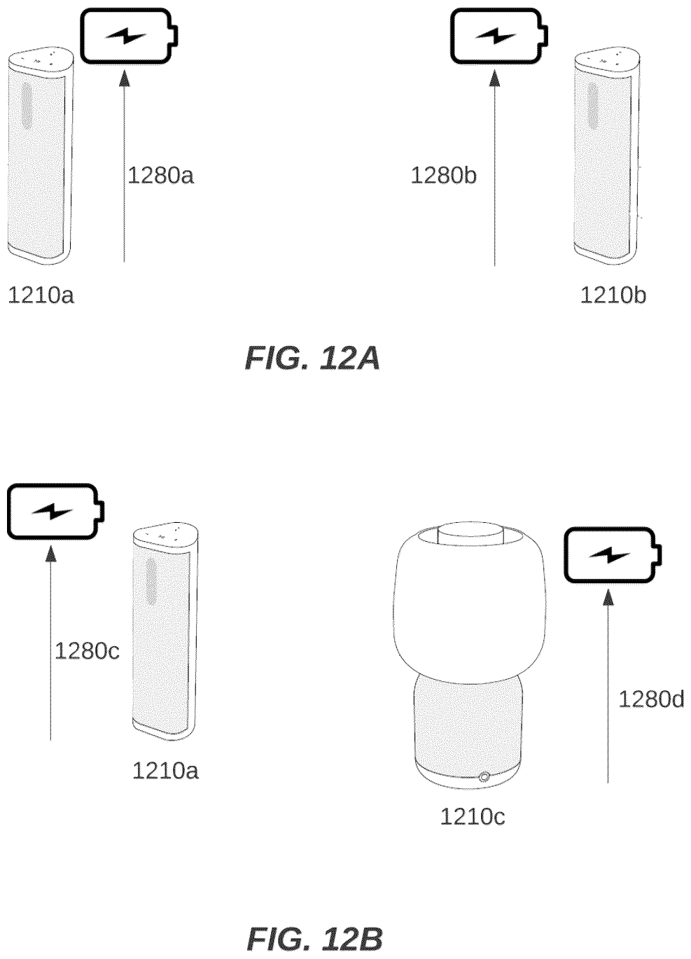

FIGS. 12A-12B illustrate examples of device charging schemes in accordance with the disclosed technology. Referring to FIGS. 12A-12B together, a first playback device 1210a (e.g., a portable playback device such as Sonos Roam) has a first maximum charge threshold according to a first charging scheme that is based on the first playback device's connection to an external power source. A battery of the first playback device 1210a receives electric power according to the first charging scheme 1280a from a power source (e.g., via an electrical power cord/cable plugged into an outlet, a vehicle power receptacle, power over ethernet (POE), another battery, one or more other playback devices, an energy harvester, a wireless power source, etc.) A second playback device 1210b has a second state according to a set of one or more second parameters and receives electric power according to a second charging scheme 1280b from a power source (either the same power source as the first playback device, a different power source, and/or a combination thereof). In the illustrated example of FIG. 12A, the first playback device 1210a and the second playback device 1210b may be operating in ungrouped state. Alternatively, for instance, one or both devices may be members (or coordinators) of different groups and/or bonded zones.

In some examples, a media playback system can receive an instruction (e.g., via a control device, via one of the playback devices, and/or via one or more remote computing device such as one or more cloud servers) to associate one or more playback devices with an event and to charge those device(s) in anticipation of the event. In some examples, the first playback device 1210a and the second playback device 1210b automatically form a new group or bonded zone (or join an existing group or bonded zone) at a predetermined period before the event in response to instructions that associate the devices with the event.

FIG. 12B illustrates the first playback device 1210a and a third playback device 1210c as part of a group and/or bonded zone such that the two devices are configured to output the same media content (or individual channels of the same media content) in synchrony or substantial synchrony. FIG. 12B shows the first playback device 1210a is configured to charge according to a charging scheme 1280c and the third playback device 1210c configured to charge according to a charging scheme 1280d. In some examples, the charging schemes 1280a and 1280c are the same, and the charging schemes 1280b and 1280d are the same. In other examples, however, the charging scheme 1280c differs from the charging scheme 1280a based on one or more attributes of the playback devices 1210a-c and charging scheme 1280d differs from the charging scheme 1280c based on one or more attributes of the playback devices 1210a-c.

For instance, according to charging scheme 1280a, the first playback device 1210a may charge to a first maximum charge threshold (e.g., 20%) while connected to an external power source. Similarly, according to charging scheme 1280b, the second playback device may charge to a second maximum charge threshold (e.g., 25%) while connected to an external power source. In some examples, charging schemes are updated in anticipation of one or more events associated with the devices. For instance, charging according to the charging scheme 1280c (rather than the charging scheme 1280a) may comprise adjusting a maximum charge threshold for playback device 1210a to 90% and configuring the first playback device 1210a to start charging at a first charge rate 5 hours before an event. Similarly, charging according to the charging scheme 1280d may comprise adjusting a maximum charge threshold for playback device 1210c to 75% and configuring the third playback device 1210c to start charging at a second charge rate 3 hours before the event, such that the first and third playback devices 1210a and 1210c reach their new maximum charge thresholds prior to being disconnected from an external power source. In some examples, the device 1210c comprises a playback device with or without transducers. In some examples, the device 1210c comprises one or more displays. In some examples, the device 1210c comprises one or more IoT devices or household appliances. In some examples, the device 1210c is a component device of and/or integrated in a vehicle (e.g., an automobile, a boat, a bus, an airplane). In some examples, at least one of the first playback device 1210a and/or the device 1210c comprises a wearable device. In operation, the first playback device 1210a receives data (such as audio content, video content, gaming content, extended reality (e.g., virtual, augmented, and/or mixed reality) content, timing information, control data, and/or other suitable data described above) and transmits the data to the device 1210c. The device 1210c may play back the data while also providing power to the first playback device 1210a. In some examples, for instance, the first playback device 1210a sends the data to the third device 1210c (e.g., one or more playback devices) for play back rather than the data being played back by the first playback device 1210a to reduce energy consumption by the first playback device 1210a.

In addition to using scheduling information as a basis for charging devices, the media playback system can use the scheduling information to configure other aspects of the media playback system. For example, the media playback system can modify one or more playlists associated with a user or a device in response to detection of an upcoming event that involves a particular artist, band, etc. Thus, if a user's calendar indicates that the user is scheduled to attend a Rolling Stones concert in three weeks, the media playback system can add songs from the Rolling Stones to one or more playlists for the user's enjoyment. Furthermore, the media playback system can generate one or more new playlists based on the artist, such as a playlists of the user's favorites albums or songs by the artist, a playlist that corresponds to the artist's most recent setlist from a live show, etc. As another example, the media playback system can pre-load audio settings for one or more devices that are customized for one or more aspects of the event, such as the location of the event, a playlist associated with the event, users associated with the event, and so on. As another example, the media playback system can use information about an event, such as its location or attendees to determine whether media with explicit content should be replaced with censored versions (if possible). For example, if an event is located at a school or is likely to include kids, the media playback system can replace songs with explicit lyrics with censored versions of those songs.

As another example, the media playback system can use scheduling information to set up ad hoc pairing or bonding between devices that are associated with the same event. In this manner, when the devices arrive at the event (or at the start time of the event) the devices associated with the event are pre-configured to automatically bond. Similarly, the media playback system can automatically pair or bond devices based on upcoming events, such as the home release date of a new movie, a televised sporting event, and so on. In this manner, the devices are preconfigured to work together at the time the event starts.

In some cases, the media playback system uses scheduling information to control what type of media can or cannot be played by certain devices and/or at what times. For example, users may schedule “quiet hours events” that the media playback system uses to prevent the volume of playback devices subject to control by the media playback system from being set above a predetermined threshold. Similarly, the media playback system can use scheduled “learning time events” to prevent playback devices from playing non-educational media. In this manner, the scheduling information allows users to control what type of media is being played and how it is being played.

In some cases, rather than powering a device down while users are away (e.g., on a long vacation), the media playback system may configure one or more playback devices to play sounds and/or control aspects of the home (e.g., lights, TV) to make it appear as though the home is occupied.

In the illustrated examples described above, the devices may be shown as audio and/or video playback devices. In some examples, however, one or more of the devices may comprise other types of devices including smartphones, tablets, video display devices (e.g., televisions, projectors), lanterns or flashlights, internet of things (IoT) devices such as sensors, cameras, microphones, thermostats, light sources, smart doorbells, etc.

### VI. Conclusion

The above discussions relating to wireless power transfer devices, playback devices, controller devices, playback zone configurations, and media/audio content sources provide only some examples of operating environments within which functions and methods described below may be implemented. Other operating environments and configurations of wireless power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1: A media playback system comprising: a first playback device with a first energy storage having a maximum storage capacity; and one or more computer-readable media having instructions stored thereon that, when executed by one or more processors, cause the media playback system to perform operations comprising: setting a target charge level for the first energy storage to a first maximum charge threshold, wherein the first maximum charge threshold is less than the maximum storage capacity, identifying a first event associated with a user, after identifying the first event, adjusting the target charge level for the first energy storage to a second maximum charge threshold, wherein the second maximum charge threshold is based on a duration of the first event, and receiving power from a first power source to charge the first energy storage to the second maximum charge threshold, and after the first event, adjusting the target charge level for the first energy storage to the first maximum charge threshold.

Example 2: The media playback system of any one of the Examples herein, wherein identifying the first event associated with the first user comprises: searching a calendar associated with the first user for one or more keywords.

Example 3: The media playback system of any one of the Examples herein, wherein identifying the first event associated with the first user comprises: receiving, from the first user, an indication of the first event, the indication of the first event including a start time and an end time.

Example 4: The media playback system of any one of the Examples herein, wherein the second maximum charge threshold is greater than the first maximum charge threshold.

Example 5: The media playback system of any one of the Examples herein, the operations further comprising: assigning a first calendar to the first playback device, the first calendar comprising one or more events.

Example 6: The media playback system of any one of the Examples herein, the operations further comprising: assigning one or more playlists to the first playback device based on the first event.

Example 7: The media playback system of any one of the Examples herein, the operations further comprising: identifying a second event associated with the first user; determining that there is a conflict between the first event and the second event; notifying the first user of the conflict between the first event and the second event; and receiving, from the first user, a ranking of the first event and the second event.

Example 8: The media playback system of any one of the Examples herein, the operations further comprising: determining that the maximum storage capacity is insufficient for the first event; and after determining that the maximum storage capacity is insufficient for the first event, identifying one or more second playback devices that each have energy storage with sufficient storage capacity for the first event, and sending, to the first user, an indication of each of the identified one or more second playback devices.

Example 9: The media playback system of any one of the Examples herein, wherein the first event has an associated start time and an associated location, the operations further comprising: at a predetermined period prior to the start time, disabling a WiFi connection between the first playback device and a controller device, and enabling a Bluetooth connection between the first playback device and the controller device.

Example 10: The media playback system of any one of the Examples herein, wherein the first playback device comprises one or more energy harvesters, the operations further comprising: retrieving weather information associated with the first event, wherein the second maximum charge threshold is based on the retrieved weather information.

Example 11: A method, performed by a media playback system comprising a first playback device with a first energy storage having a maximum storage capacity, the method comprising: setting a target charge level for the first energy storage to a first maximum charge threshold, wherein the first maximum charge threshold is less than the maximum storage capacity, identifying a first event associated with a user, after identifying the first event, adjusting the target charge level for the first energy storage to a second maximum charge threshold, wherein the second maximum charge threshold is based on a duration of the first event, and receiving power from a first power source to charge the first energy storage to the second maximum charge threshold, and after the first event, adjusting the target charge level for the first energy storage to the first maximum charge threshold.

Example 12: The method of any one of the Examples herein, wherein identifying the first event associated with the first user comprises: searching a calendar associated with the first user for one or more keywords.

Example 13: The method of any one of the Examples herein, wherein identifying the first event associated with the first user comprises: receiving, from the first user, an indication of the first event, the indication of the first event including a start time and an end time.

Example 14: The method of any one of the Examples herein, wherein the second maximum charge threshold is less than the first maximum charge threshold.

Example 15: The method of any one of the Examples herein, further comprising: assigning a first calendar to the first playback device, the first calendar comprising one or more events.

Example 16: The method of any one of the Examples herein, further comprising: assigning one or more playlists to the first playback device based on the first event.

Example 17: The method of any one of the Examples herein, further comprising: identifying a second event associated with the first user; determining that there is a conflict between the first event and the second event; notifying the first user of the conflict between the first event and the second event; and receiving, from the first user, a ranking of the first event and the second event.

Example 18: The method of any one of the Examples herein, further comprising: determining that the maximum storage capacity is insufficient for the first event; and after determining that the maximum storage capacity is insufficient for the first event, identifying one or more second playback devices that each have energy storage with sufficient storage capacity for the first event, and sending, to the first user, an indication of each of the identified one or more second playback devices.

Example 19: The method of any one of the Examples herein, wherein the first event has an associated start time and an associated location, further comprising: at a predetermined period prior to the start time, disabling a WiFi connection between the first playback device and a controller device, and enabling a Bluetooth connection between the first playback device and the controller device.

Example 20: The method of any one of the Examples herein, wherein the first playback device comprises one or more energy harvesters, further comprising: retrieving weather information associated with the first event, wherein the second maximum charge threshold is based on the retrieved weather information.

Example 21: One or more tangible, non-transitory computer-readable media storing instructions that, when executed by one or more processors of a media playback system comprising a first playback device with a first energy storage having a maximum storage capacity, cause the media playback system to perform operations comprising: setting a target charge level for the first energy storage a first maximum charge threshold, wherein the first maximum charge threshold is less than the maximum storage capacity, identifying a first event associated with a user, after identifying the first event, adjusting the target charge level for the first energy storage to a second maximum charge threshold, wherein the second maximum charge threshold is based on a duration of the first event, and receiving power from a first power source to charge the first energy storage to the second maximum charge threshold, and after the first event, adjusting the target charge level for the first energy storage to the first maximum charge threshold.

Example 22: The one or more tangible, non-transitory computer-readable media of any one of the Examples herein, wherein identifying the first event associated with the first user comprises: searching a calendar associated with the first user for one or more keywords.

Example 23: The one or more tangible, non-transitory computer-readable media of any one of the Examples herein, wherein identifying the first event associated with the first user comprises: receiving, from the first user, an indication of the first event, the indication of the first event including a start time and an end time.

Example 24: The one or more tangible, non-transitory computer-readable media of any one of the Examples herein, wherein the second maximum charge threshold is greater than the first maximum charge threshold.

Example 25: The one or more tangible, non-transitory computer-readable media of any one of the Examples herein, the operations further comprising: assigning a first calendar to the first playback device, the first calendar comprising one or more events.

Example 26: The one or more tangible, non-transitory computer-readable media of any one of the Examples herein, the operations further comprising: assigning one or more playlists to the first playback device based on the first event.

Example 27: The one or more tangible, non-transitory computer-readable media of any one of the Examples herein, the operations further comprising: identifying a second event associated with the first user; determining that there is a conflict between the first event and the second event; notifying the first user of the conflict between the first event and the second event; and receiving, from the first user, a ranking of the first event and the second event.

Example 28: The one or more tangible, non-transitory computer-readable media of any one of the Examples herein, the operations further comprising: determining that the maximum storage capacity is insufficient for the first event; and after determining that the maximum storage capacity is insufficient for the first event, identifying one or more second playback devices that each have energy storage with sufficient storage capacity for the first event, and sending, to the first user, an indication of each of the identified one or more second playback devices.

Example 29: The one or more tangible, non-transitory computer-readable media of any one of the Examples herein, wherein the first event has an associated start time and an associated location, the operations further comprising: at a predetermined period prior to the start time, disabling a WiFi connection between the first playback device and a controller device, and enabling a Bluetooth connection between the first playback device and the controller device.

Example 30: The one or more tangible, non-transitory computer-readable media of any one of the Examples herein, wherein the first playback device comprises one or more energy harvesters, the operations further comprising: retrieving weather information associated with the first event, wherein the second maximum charge threshold is based on the retrieved weather information.

1. A media playback system comprising:
a first playback device with a first energy storage having a maximum storage capacity; and
one or more computer-readable media having instructions stored thereon that, when executed by one or more processors, cause the media playback system to perform operations comprising:
setting a target charge level for the first energy storage to a first maximum charge threshold, wherein the first maximum charge threshold is less than the maximum storage capacity,
identifying a first event associated with a first user,
after identifying the first event,
adjusting the target charge level for the first energy storage to a second maximum charge threshold, wherein the second maximum charge threshold is based on a duration of the first event, and
receiving power from a first power source to charge the first energy storage to the second maximum charge threshold, and
after the first event, adjusting the target charge level for the first energy storage to the first maximum charge threshold.

2. The media playback system of claim 1, wherein identifying the first event associated with the first user comprises:
searching a calendar associated with the first user for one or more keywords.

3. The media playback system of claim 1, wherein identifying the first event associated with the first user comprises:
receiving, from the first user, an indication of the first event, the indication of the first event including a start time and an end time.

4. The media playback system of claim 1, wherein the second maximum charge threshold is greater than the first maximum charge threshold.

5. The media playback system of claim 1, the operations further comprising:
assigning a first calendar to the first playback device, the first calendar comprising one or more events.

6. The media playback system of claim 1, the operations further comprising:
assigning one or more playlists to the first playback device based on the first event.

7. The media playback system of claim 1, the operations further comprising:
identifying a second event associated with the first user;
determining that there is a conflict between the first event and the second event;
notifying the first user of the conflict between the first event and the second event; and
receiving, from the first user, a ranking of the first event and the second event.

8. The media playback system of claim 1, the operations further comprising:
determining that the maximum storage capacity is insufficient for the first event; and
after determining that the maximum storage capacity is insufficient for the first event,
identifying one or more second playback devices that each have energy storage with sufficient storage capacity for the first event, and
sending, to the first user, an indication of each of the identified one or more second playback devices.

9. The media playback system of claim 1, wherein the first event has an associated start time and an associated location, the operations further comprising:
at a predetermined period prior to the start time,
disabling a WiFi connection between the first playback device and a controller device, and
enabling a Bluetooth connection between the first playback device and the controller device.

10. The media playback system of claim 1, wherein the first playback device comprises one or more energy harvesters, the operations further comprising:
retrieving weather information associated with the first event, wherein the second maximum charge threshold is based on the retrieved weather information.

11. A method, performed by a media playback system comprising a first playback device with a first energy storage having a maximum storage capacity, the method comprising:
setting a target charge level for the first energy storage to a first maximum charge threshold, wherein the first maximum charge threshold is less than the maximum storage capacity,
identifying a first event associated with a first user,
after identifying the first event,
adjusting the target charge level for the first energy storage to a second maximum charge threshold, wherein the second maximum charge threshold is based on a duration of the first event, and
receiving power from a first power source to charge the first energy storage to the second maximum charge threshold, and
after the first event, adjusting the target charge level for the first energy storage to the first maximum charge threshold.

12. The method of claim 11, wherein identifying the first event associated with the first user comprises:
searching a calendar associated with the first user for one or more keywords.

13. The method of claim 11, wherein identifying the first event associated with the first user comprises:
receiving, from the first user, an indication of the first event, the indication of the first event including a start time and an end time.

14. The method of claim 11, wherein the second maximum charge threshold is less than the first maximum charge threshold.

15. The method of claim 11, further comprising:
assigning a first calendar to the first playback device, the first calendar comprising one or more events.

16. The method of claim 11, further comprising:
assigning one or more playlists to the first playback device based on the first event.

17. The method of claim 11, further comprising:
identifying a second event associated with the first user;
determining that there is a conflict between the first event and the second event;
notifying the first user of the conflict between the first event and the second event; and
receiving, from the first user, a ranking of the first event and the second event.

18. The method of claim 11, further comprising:
determining that the maximum storage capacity is insufficient for the first event; and
after determining that the maximum storage capacity is insufficient for the first event,
identifying one or more second playback devices that each have energy storage with sufficient storage capacity for the first event, and
sending, to the first user, an indication of each of the identified one or more second playback devices.

19. The method of claim 11, wherein the first event has an associated start time and an associated location, further comprising:
at a predetermined period prior to the start time,
disabling a WiFi connection between the first playback device and a controller device, and
enabling a Bluetooth connection between the first playback device and the controller device.

20. One or more tangible, non-transitory computer-readable media storing instructions that, when executed by one or more processors of a media playback system comprising a first playback device with a first energy storage having a maximum storage capacity, cause the media playback system to perform operations comprising:
setting a target charge level for the first energy storage a first maximum charge threshold, wherein the first maximum charge threshold is less than the maximum storage capacity,
identifying a first event associated with a first user,
after identifying the first event,
adjusting the target charge level for the first energy storage to a second maximum charge threshold, wherein the second maximum charge threshold is based on a duration of the first event, and
receiving power from a first power source to charge the first energy storage to the second maximum charge threshold, and
after the first event, adjusting the target charge level for the first energy storage to the first maximum charge threshold.
